(19) United States
(12) Patent Application Publication
(10) Pub. No.: US 2026/0003144 A1
(43) Pub. Date: Jan. 1, 2026

(54) SELF-LOCKING OPTICAL CONNECTOR FOR PHOTONIC INTEGRATED CIRCUITS

(71) Applicant: Intel Corporation, Santa Clara, CA (US)

(72) Inventors: Li Yuan, Fremont, CA (US); Dekang Chen, Chandler, AZ (US); Feifei Cheng, Chandler, AZ (US); Fan Fan, Chandler, AZ (US); Saikumar Jayaraman, Chandler, AZ (US); Kumar Abhishek Singh, Phoenix, AZ (US)

(73) Assignee: Intel Corporation, Santa Clara, CA (US)

(21) Appl. No.: 18/754,509

(22) Filed: Jun. 26, 2024

(51) Int. Cl. G02B 6/42

(52) U.S. Cl. CPC G02B 6/4284; G02B 6/4228; G02B 6/4249; G02B 6/428

(57) ABSTRACT

An optical connector, a semiconductor assembly including the optical connector, a multi-chip package including the optical connector, and a method of making the optical connector. The optical connector includes: a first lid; and a second lid attached to the first lid to define a cavity therebetween. Individual ones of the first lid and the second lid include: a substrate having an inner surface facing the cavity, an outer surface opposite the inner surface, a first end and a second end, the first end to receive a corresponding waveguide therein; and a concave mirror on the substrate and having a reflective surface facing the cavity, wherein a straight linear optical axis is to extend between the reflective surface of the concave mirror and a photonic structure at an opposing one of said individual ones of the first lid and the second lid.

### STATEMENT OF GOVERNMENT INTEREST

This invention was made with Government support under Agreement No. N00164-19-9-0001, awarded by NSWC Crane Division. The Government has certain rights in the invention.

### BACKGROUND

Silicon photonics combines integrated circuits and semiconductor photonic devices or photonics integrated circuits (PICs). A PIC includes a semiconductor device that integrates multiple photonic components on a single chip, similar to how electronic circuits integrate multiple electronic components on a single chip. These photonic components can include micro-ring resonators (MRR), waveguides, lasers, and detectors, among others. PICs can be used for a wide range of applications such as optical communications, sensing, and biomedical imaging.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 is a cross sectional view of a semiconductor assembly attached to a fiber array unit (FAU) according to an embodiment.

FIG. 2 is a top plan view of a semiconductor assembly similar to the semiconductor assembly of FIG. 1 according to an embodiment.

FIG. 3A is a perspective view of an optical connector and attached fiber optic cables therein according to a first embodiment.

FIG. 3B is a cross-sectional view of the optical connector of FIG. 3A.

FIG. 4A is a perspective view of an optical connector and attached fiber optic cables therein according to a second embodiment.

FIG. 4B is a cross-sectional view of the optical connector of FIG. 4A.

FIG. 5A is a cross-sectional view of an optical connector similar to the view of FIG. 4B according to a variation of the second embodiment of FIGS. 4A and 4B, further showing a more detailed ray map.

FIG. 5B is a graph plotting coupling loss versus connector lateral offset for an expanded beam connector on one hand, and for self-locking connector according to an embodiment.

FIG. 6A is a schematic perspective view of a spherical lens, or a spherical concave mirror.

FIG. 6B is a schematic view similar to that of FIG. 6A, showing a schematic perspective view of a toric lens, or a toric concave mirror.

FIG. 6C is a graph plotting coupling loss versus connector lateral offset for a toric lens on one hand, and for a spherical lens on the other hand.

FIG. 7A is a schematic cross-sectional view of an expanded beam optical connector.

FIG. 7B is a schematic view similar to that of FIG. 7A, but showing an optical connector according to an embodiment.

FIG. 8A is a schematic view of a deconstructed version of the expanded beam optical connector of FIG. 7A.

FIG. 8B is a schematic view of a deconstructed version of the optical connector of FIG. 7B.

FIG. 9A is a perspective view of an inner surface of a lid of an optical connector according to an embodiment.

FIG. 9B is a perspective view of a top surface of the lid of FIG. 9A.

FIG. 10A is a perspective view of a sheet of material being molded to form substrates of lids for optical connectors according to an embodiment.

FIG. 10B is a perspective view of a panel of interconnected lids for optical connectors according to an embodiment undergoing a cutting or singulation process

FIG. 10C shows a matrix of monolithic lids for an optical connector according to some embodiments, depicting an example after panel-level molding and cutting processes.

FIG. 11 is a flow chart of a process according to some embodiments.

FIG. 12 is a top view of a wafer and dies that may be included in a semiconductor assembly, in accordance with any of the embodiments disclosed herein.

FIG. 13 is a simplified cross-sectional side view showing an implementation of an integrated circuit on a die that may be included in various embodiments in accordance with any of the embodiments disclosed herein.

FIG. 14 is a cross-sectional side view of a semiconductor multi-chip package that may include any of the embodiments disclosed herein.

FIG. 15 is a block diagram of an example electrical device that may include one or more of the embodiments disclosed herein.

### DETAILED DESCRIPTION

Some embodiments provide a self-locking optical connector including an assembled pair of concave mirrors to maintain an inherent symmetry in the light path through the connector, thereby ensuring high coupling efficiency even with high lateral misalignment.

Advantageously, some embodiments result in improvement in performance, sometimes achieving 2 to 3 times the efficiency of traditional EB-based connectors with the same Mode Field Diameter (MFD). MFD refers to the effective diameter of the optical power distribution in a single-mode fiber, which is the region where most of the light energy is confined and propagated. Additionally, advantageously, with some embodiments, the tilt alignment can be precisely controlled using co-planar contact methods, such as employing a glass housing step or spacer component that maintains very tight surface flatness tolerances. A precise control of tilt alignment can ensure that the optical components are accurately positioned, advantageously reducing alignment errors and improving overall performance.

Furthermore, by utilizing monolithic glass-based manufacturing techniques, the boundaries between different optical components are eliminated. Instead of having separate components that need to be aligned and assembled, they are integrated into a single monolithic piece. This integration according to some embodiments can lead to several unique advantages over conventional EB-based optical connectors, including:
elimination of separate component boundaries allows for more accurate alignment of optical elements, enhancing signal quality;
a monolithic design can lead to a more precise manufacturing process, reducing variations and defects;
an integrated design that is compatible with reflow soldering processes, making the connector easier to assemble and reducing the risk of misalignment during manufacturing; and/or
a streamlined manufacturing process and integrated design that enable higher production throughput, reducing costs and increasing efficiency.

Overall, these improvements result in a substantial performance boost and operational efficiency, making these embodiments highly advantageous compared to traditional EB-based optical connectors.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims. In the following description, various aspects of the illustrative implementations will be described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations are set forth in order to provide a thorough understanding of the illustrative implementations. However, it will be apparent to one skilled in the art that embodiments of the present disclosure may be practiced without the specific details. In other instances, well-known features are omitted or simplified in order not to obscure the illustrative implementations.

In the following detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

The technologies described herein may be implemented in one or more electronic devices. Non-limiting examples of electronic devices that may utilize the technologies described herein include any kind of mobile device and/or stationary device, such as microelectromechanical systems (MEMS) based electrical systems, gyroscopes, advanced driving assistance systems (ADAS), 5G communication systems, cameras, cell phones, computer terminals, desktop computers, electronic readers, facsimile machines, kiosks, netbook computers, notebook computers, internet devices, payment terminals, personal digital assistants, media players and/or recorders, servers (e.g., blade server, rack mount server, combinations thereof, etc.), set-top boxes, smart phones, tablet personal computers, ultra-mobile personal computers, wired telephones, combinations thereof, and the like. Such devices may be portable or stationary. In some embodiments, the technologies described herein may be employed in a desktop computer, laptop computer, smart phone, tablet computer, netbook computer, notebook computer, personal digital assistant, server, combinations thereof, and the like. More generally, the technologies described herein may be employed in any of a variety of electronic devices, including semiconductor packages with passive heat spreaders, interface layers, TIMs, top dies, side dies, substrates, and package substrates.

As used herein the terms “top,” “bottom,” “upper,” “lower,” “lowermost,” and “uppermost” when used in relationship to one or more elements are intended to convey a relative rather than absolute physical configuration. Thus, an element described as an “uppermost element” or a “top element” in a device may instead form the “lowermost element” or “bottom element” in the device when the device is inverted. Similarly, an element described as the “lowermost element” or “bottom element” in the device may instead form the “uppermost element” or “top element” in the device when the device is inverted.

As used herein, reference to a “die” is meant to broadly refer to a die, a chiplet, a chip complex, a chiplet complex, or any other integrated circuit structure including circuitry therein that is supported on a substrate. While the terms die, chip, and chiplet may be used interchangeably, the term chiplet is sometimes used to refer to an integrated circuit die that implements a subset of the functionality of a larger integrated circuit component, the larger integrated circuit component formed using one or more chiplets connected by inter-die interconnects (e.g., interposers, bridges, local interconnect components, local silicon interconnects). The use of chiplets in integrated circuit components has become attractive as feature sizes have reduced and the demand for high-performance larger integrated circuit components has increased. The approach of assembling multiple known-good dies (chiplets) to form a larger integrated circuit component results in improved manufacturing efficiencies as the overall yield of an integrated circuit component assembled from multiple small chiplets is better than that of an integrated circuit component in which the functionality of the chiplets is implemented on a single large integrated circuit die. Any integrated circuit die, chip, or chiplet can implement any portion of the functionality of any processor unit described or referenced herein.

As used herein, the term “the material” of component A may refer to one or more constituent materials of component A. For example, where component A includes 3 sublayers made of three respective materials X, Y and Z, the disclosure herein may refer to “the material of component A” to refer to one or more of materials X, Y and Z that make up component A.

As used herein, the term “electronic component” can refer to an active electronic circuit/active electronic component (e.g., processing unit, die, chiplet, memory, High Bandwidth Memory (HBM), storage device, FET, etc.) or a passive electronic circuit/passive electronic component (e.g., resistor, inductor, capacitor, etc.).

As used herein, the term “electronic integrated circuit component” (or EIC, or IC component) can refer to an electronic component that may be integrated in a semiconductor assembly and configured to perform a function using electricity to communicate signals. An EIC can comprise one or more of any electronic components, such as any electronic components described or referenced herein, or any other computing system component, such as a processor unit (e.g., system-on-a-chip (SoC), processor core, graphics processor unit (GPU), accelerator, chipset processor), I/O controller, memory, or network interface controller, and can comprise one or more additional active or passive devices such as capacitors, decoupling capacitors, resistors, inductors, fuses, diodes, transformers, sensors, electrostatic discharge (ESD) devices, and memory devices.

A non-limiting example of an unpackaged IC component includes a single monolithic IC die (shortened herein to “die”); the die may include solder bumps attached to contacts on the die. When present on the die, the solder bumps can enable the die to be directly attached to a printed circuit board (PCB).

As used herein, the term “optical component” can refer to an optical device that may be integrated in a semiconductor assembly, and configured to perform a function using light to communicate signals. An optical component may for example comprise one or more of: an optical modulator (e.g., used to modulate the amplitude or phase of light in optical-based optical circuits, such as a MRR or a Mach-Zehnder interferometer (MZI)), an optical photodetector (e.g., used to convert optical signals into electrical signals in optical-based optical circuits), an optical filter (e.g., used to selectively filter out certain wavelengths of light in optical-based optical circuits), an optical coupler (e.g., used to couple light into and out of optical waveguides in optical-based optical circuits), an optical mirror (e.g., used to reflect light in optical-based optical circuits), an optical splitter (e.g., used to split an incoming optical signal into multiple output signals in optical-based optical circuits), an optical switch (e.g., used to route optical signals between different waveguides or channels in optical-based optical circuits), an optical amplifier (e.g., used to amplify optical signals in optical-based optical circuits), or an optical laser (e.g., used to generate coherent light in optical-based optical circuits.

In various embodiments, an optical component may be located on a silicon-on-insulator (SOI) wafer, where the substrate may include silicon.

As referred to herein, a “PIC” refers to a device that integrates one or more photonic components onto a single chip or substrate, similar to how integrated circuits integrate one or more electronic components onto a single chip. PICs are used in optical communication, sensing, and computing applications and are designed to enable the miniaturization and integration of complex optical systems. A photonic integrated circuit typically includes a series of photonic components, such as lasers, modulators, detectors, filters, and waveguides, that are integrated on a common substrate, such as silicon or indium phosphide. The optical components are connected to each other through waveguides, which guide and direct the flow of light signals. The optical components are typically fabricated using lithographic techniques that allow for the precise control of their dimensions and placement.

PICs can offer several advantages over traditional optical systems, including reduced size, weight, and power consumption. They can also offer improved performance and reliability, as the integration of multiple components reduces the number of optical connections and potential sources of signal loss or interference.

PICs can be used in a variety of applications, including telecommunications, data centers, medical imaging, and environmental sensing. They are also being explored for use in emerging fields such as quantum computing and sensing, where their ability to integrate multiple optical functions on a single chip offers significant advantages.

As used herein, a “semiconductor component” refers to a semiconductor device, such as an electronic or photonic or MEMs component made from semiconductor material that exhibits a specific behavior and/or performs one or more specific functions. The operation of a semiconductor device relies in part on the properties of semiconductor materials, which have conductivity (e.g., with electricity and/or light) between that of conductors and insulators. The electrical conductivity of a semiconductor can be controlled and modified by introducing impurities, a process known as doping. Doping creates areas of excess electrons or holes within the material, allowing for the controlled flow of current through the device. The optical conductivity within an optical component may be controlled by controlling the refractive indices of waveguides therein. Examples of semiconductor components or semiconductor devices include ICs and/or PICs.

As used herein, a “semiconductor assembly” refers to a structure corresponding to an assembly of individual semiconductor components, such as integrated circuits (ICs) and/or PICs, onto a substrate or package. The assembly process may involve several steps, including component attach, wire bonding or flip-chip bonding, encapsulation, and testing. In the component attach process, the semiconductor component is attached to a substrate or lead frame using an adhesive or solder. In the wire bonding process, thin wires are used to connect the bond pads on the component to the corresponding pads on the substrate or lead frame. In flip-chip bonding, the component is flipped and bonded directly to the substrate or package, allowing for higher-density connections and shorter wire lengths. After the semiconductor component attach and interconnection process, the assembly may be encapsulated with a protective material, such as epoxy or plastic, to provide mechanical protection and environmental stability. Finally, the assembly may be tested to ensure that it meets the design specifications and performance requirements.

As used herein, “contacts” may refer to electrically conductive structures of or on a first microelectronic component (e.g., an electronic component, a substrate, a panel layer, etc.) that may be electrically coupled to contacts of a second microelectronic component. Contacts may include, for example, solder balls, pads, or pins.

“Electrically conductive structures” as used herein may include an electrically conductive material such as a metal (e.g., copper, aluminum, nickel, cobalt, iron, tin, gold, silver, or combinations thereof). Examples of electrically conductive structures may include traces, which extend horizontally, and vias, which extend vertically.

By “A is embedded in B,” what is meant herein is that B at least partially covers all side surfaces of A, and at most covers all surfaces of A.

An existing example of a packaged semiconductor assembly comprises one or more integrated circuit dies mounted on a package substrate with the integrated circuit dies and package substrate encapsulated in a casing material, such as a metal, plastic, glass, or ceramic. Often the casing includes an integrated heat spreader (IHS); the packaged integrated circuit component often has bumps, leads, or pins attached to the package substrate (either directly or by wires attaching the bumps, leads, or pins to the package substrate) for attaching the packaged integrated circuit component to a printed circuit board (or motherboard or base board) or another component.

The following detailed description is not intended to limit the application and use of the disclosed technologies. It may be evident that the novel embodiments can be practiced without every detail described herein. For the sake of brevity, well-known structures and devices may be shown in block diagram form to facilitate a description thereof.

For the purposes of the present document, the phrases “A or B” and “A/B” mean (A), (B), or (A and B).

For convenience, a phrase referring to element “X,” where X is a reference numeral, may be used to refer to any one of elements XA or XB where elements have been disclosed as such and marked as such on the accompanying drawings. For convenience, a phrase referring to element “XA/XB,” where X is a reference numeral, may be used to refer to either element XA or element XB depending on the context.

Semiconductor assemblies, and related devices and methods, are disclosed herein.

In co-packaged optics (CPO), optical components are integrated closely with electronic components within the same package or module. In a CPO scenario, detachable non-contact optical connector solutions rely on traditional expanded beam (EB) coupling, including horizontal coupling and vertical coupling. CPOs are designed to improve performance and reduce latency by minimizing the distance that optical signals must travel between components, which is particularly important in high-speed data transmission and processing applications. EB coupling methods involve spreading the optical signal over a larger area to facilitate easier alignment and connection between optical components. However, EB connectors present challenges in achieving accurate alignment with lateral, angular, and longitudinal control simultaneously. These challenges arise because precise alignment is critical for ensuring efficient light transmission between the optical and electronic components.

Some embodiments advantageously provide an improved coupling and alignment strategy to solve the above challenges, thereby enhancing the performance and reliability of CPOs by ensuring more accurate and stable connections between optical components.

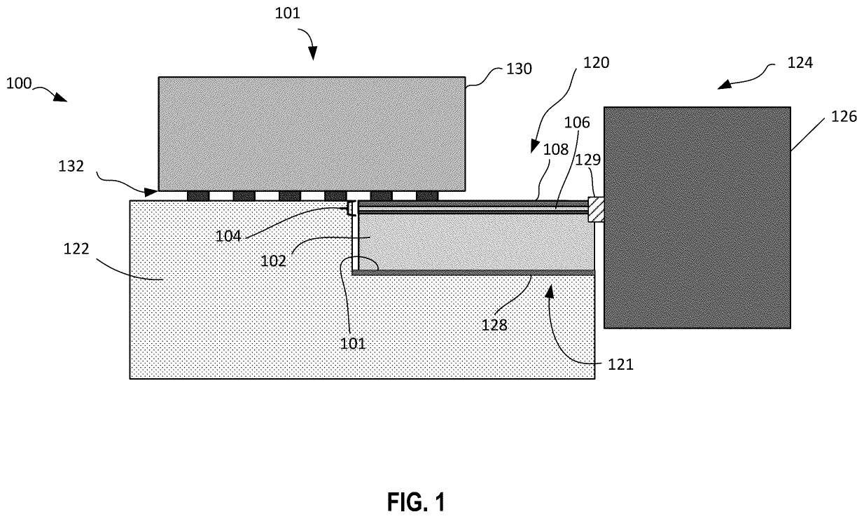

Reference is now made to FIG. 1, which shows a semiconductor assembly 100 including a PIC 120 according to some embodiments. The semiconductor assembly 100 includes a multi-chip package (MCP) 101 and shows the MCP having been coupled to a fiber array unit (FAU) 126 by way of an optical connector 129.

Package substrate 122 may include, by way of example, a core layer and build-up layers on one side or on both sides of the core layer (not shown), where the core layer includes a non-conductive material, such as glass, silicon or an organic material (e.g., epoxy). The build-up layers may include successive non-conductive layers and successive metal layers (or redistribution layers (RDLs) (e.g., M1, M2, . . . . Mn) between the dielectric layers.

The PIC 120 is shown as resting on a ledge region 121 defined by the package substrate, and as having been mechanically affixed to the package substrate by way of an adhesive layer 128, such as a double-sided adhesive film (DAF). IC component 130 may be electrically coupled to the PIC 120 by way of a number of the bumps 132 as shown. Electrical signals from the IC component 130 may be converted to corresponding optical signals within the PIC 120, and vice versa, through one or more electro-optic modulators of PIC 120. Electro-optic modulators are one form of optical components, and may include Mach-Zehnder interferometers (MZI), electro-absorption modulators, and phase modulators, to name a few.

Light may be coupled into and out of PIC 120 for signal communication therewith using optical connector 129, an example of an optical connector 129, which may take the form of an edge connector that can couple light from one or more waveguides, such as optical fibers, on the edge of the PIC to one or more external waveguides, such as a fiber array unit (FAU) 126. Optical connectors can be manufactured using a variety of techniques, including fiber alignment, lithography, and etching.

The PIC 120 may be coupled to the optical connector 129 either directly, that is, by way of waveguides of the PIC 120 positioned to couple light directly into the connector 129, or it may be coupled to the optical connector 129 by way of a fiber array (array of fiber optic cables/array of optical fibers) fixed to the optical connector 129.

Optical connector 129 is coupled to a fiber array unit (FAU) 126 as shown. According to an example, FAU 126 may include an array of optical fibers that are precisely aligned and terminated at both ends. The fibers are typically arranged in a linear array or a two-dimensional grid, and are used to transmit or receive light signals. FAU 126 may be used in optical switching and routing applications where multiple fibers need to be connected and routed to different locations.

Although the embodiment of FIG. 1 shows a PIC coupled to an FAU, some embodiments contemplate the use of an optical connector for a PIC to PIC coupling, such as for an on-package PIC to PIC coupling.

To solve some challenges of EB based optical connectors as noted above, some embodiments propose a self-locking based monolithic connector assembly. By “self-locking” in the context of a connector assembly, what is meant here is a connector assembly where a specific geometric relationship between the optical components of the optical connector allows an increase in offset tolerance between portions of the connector assembly which may, depending on the embodiment, reduce or even substantially offset reliance on an expanded beam. According to some embodiments, associated micro-optic components of an optical connector may be integrated into monolithic lids to eliminate optical boundary issues and preserve precise geometric positioning.

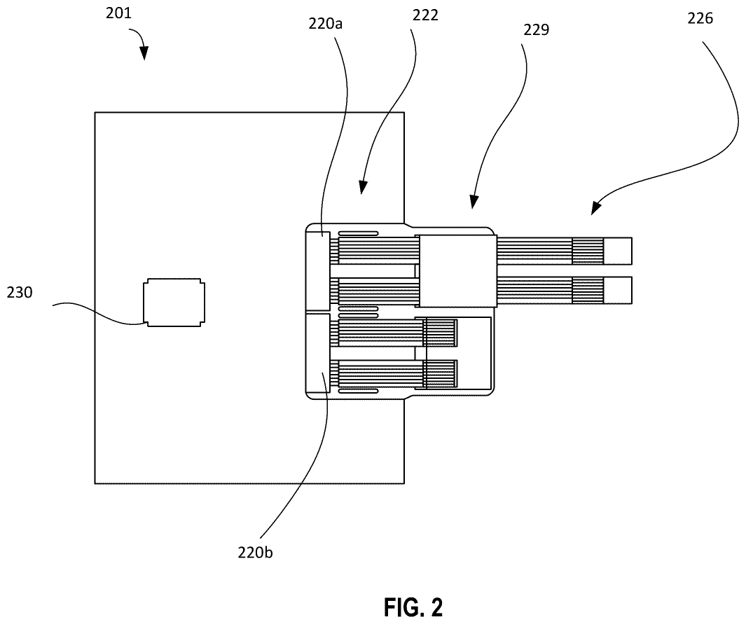

Referring now to FIG. 2, a top plan view is shown of a semiconductor assembly 200 according to some embodiments, similar to the semiconductor assembly 100 of FIG. 1 is depicted. In FIG. 2, like components compared to those of FIG. 1 are labeled with like reference numerals. Semiconductor assembly 200 includes the IC component 230 (e.g., an XPU as shown in the example of FIG. 2), and PICs 220a and 220b. Optical fibers 222 are coupled to the PIC 220a to communicate light signals between the PICS 220a and fiber arrays of an FAU 226. An self-locking optical connector 229 according to some embodiments connects the optical fibers 222 at the edge of PIC 220a with the FAU 226.

### Self-Locking Optical Connector

An “optical connector” as used herein refers to a structural component that is to serve as an interface to facilitate optical coupling between two optical components, such as between a PIC and a FAU or between two PICs. An optical connector according to embodiments includes a pair of assembled lids. The lids of an optical connector according to embodiments include a first lid (e.g. a top lid) and a second lid (e.g. a bottom lid). Individual ones of the first lid and second lid each include a substrate having a first end and a second end. Individual ones of the first end and the second end are configured to receive a waveguide therein one or more reflective micro-optic components on the substrate, the one or more reflective micro-optic components including a concave mirror

It ensures precise alignment and stable connection to minimize loss and maximize the efficiency of light transmission.

These connectors are typically designed to handle high precision and small tolerances due to the sensitive nature of optical signals.

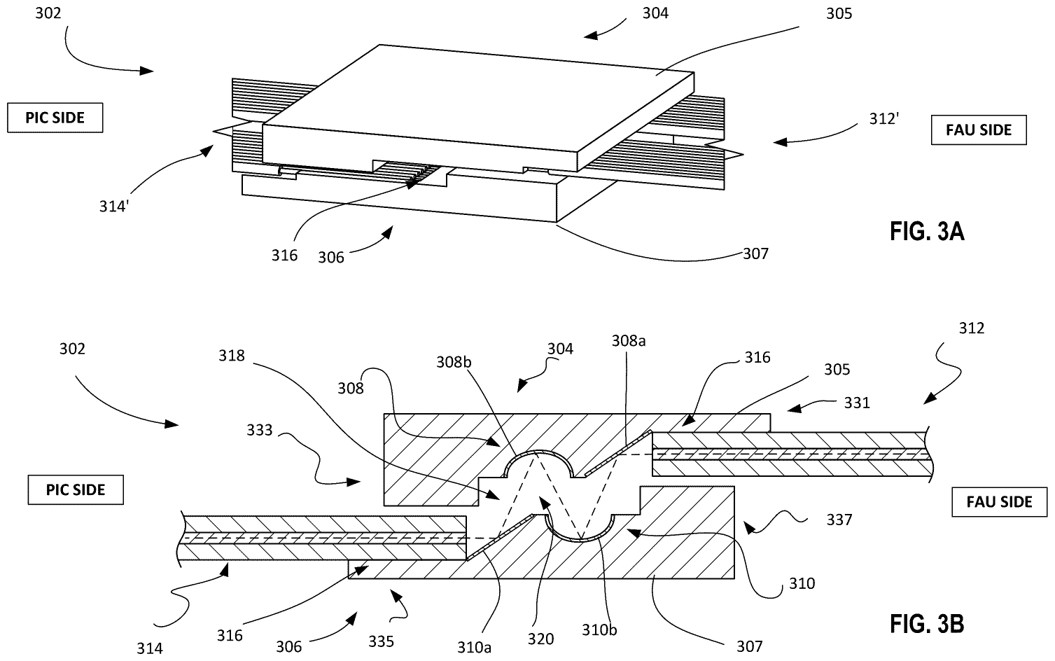

Let us now refer to FIGS. 3A and 3B, which a first embodiment of a self-locking optical connector, such as a self-locking monolithic detachable optical connector. FIG. 3A shows a perspective view of a pair of lids that are in a mating position to for the optical connector 302. FIG. 3B shows a longitudinal cross section through the optical connector 302 of FIG. 3A, depicting a light path through the optical connector of FIG. 3A.

FIG. 3A shows the optical connector 302 as including top lid 304 and bottom lid 306, where the top and bottom lids may be manufactured from a variety of material options that include glass, ceramic, or polymer. The material may be optically transparent or optically non-transparent. The optical connector may provide an interface that facilitates the coupling between the PIC and the FAU, and may increase alignment precision and a stable connection to minimize loss and maximize the efficiency of light transmission.

These connectors are typically designed to handle high precision and small tolerances due to the sensitive nature of optical signals. In FIG. 3B, light travels through a cavity 320 defined between respective inner facing surfaces of the top lid 304 and the bottom lid 306. The cavity is bounded by surfaces that include the planar mirrors 308a and 310a and the concave mirrors 308b and 310b, and may be an air cavity, or filled with a transparent material, such as glass or epoxy. For example, the top and bottom lids may include, respectively, a substrate 305/307 made of glass and/or a monolithic substrate. Each of the top lid 304 and bottom lid 306 may be substantially planar at externally facing or outer surfaces thereof (i.e., faces thereof to face externally when the top lid and the bottom lid are in a mated configuration), as shown for example in FIGS. 3A and 3B. The top lid 304 may include reflective micro-optic components 308 that include a planar mirror 308a and a concave mirror 308b fixed to substrate 305 at the inner surface of top lid 304. The bottom lid 306 may include reflective micro-optic components 310 that include a planar mirror 310a and a concave mirror (e.g., micromirror) 310b fixed to substrate 307 at the inner surface of bottom lid 306. The top and bottom lids as shown are rotationally symmetrical with respect to one another. Each side of each lid may be provided with an integrated protrusion functioning as a spacer to control the working distances of the reflective micro-optic components with respect to one another.

As suggested in FIG. 3A, top lid 304 and bottom lid 306 are configured to secure a number of fiber optic cables therein in respective arrays 312′ and 314′, two fiber optic cables of which, 312 and 314, are shown in FIG. 3B by virtue of the cross sectional view depicted in the latter. For example, as seen in FIGS. 3A and 3B, inner surfaces of each of the top lid and bottom lid may be provided with an array of grooves 316 to accommodate a corresponding array of fiber optic cables therein.

The grooves may, for example, include V-shaped grooves. The array of grooves 316 can provide alignment of the optical fiber to the micromirror array during device assembly. Optical fiber arrays 312′ and 314′ can be, for example, single mode optical fibers (SMF), polarization maintenance fiber (PMF), or multimode fibers (MMF). The optical fiber arrays 312′ and 314′314 can be assembled directly into the grooves, for example using a ribbon-based assembly for each fiber array, providing simple multichannel functionality in one process. The optical fibers may be bonded in place using an adhesive and optionally held in place by a cap piece (not shown) which pushes the fibers down into the grooves during an adhesive curing process.

Each of the top lid 304 and bottom lid 306 may further include mechanical alignment features (not shown) which mate with one another in order to align the top lid to the bottom lid. The alignment features may consist of combinations of protrusions and corresponding cavities, for example hemispheric bumps and pyramidal cavities. The alignment features can be the same on both sides, or can have opposing genders. The lids can each include a monolithic manufactured block of material, such as, for example glass, a polymer, ceramic or other material.

The reflective micro-optic components can be, for example, total internal reflection (TIR) mirrors, or alternatively they can be a reflective material, such as a metal, that is a coating attached to inner surfaces of lids 304 and 306. Preferably, all optical reflective components according to some embodiments include a High Reflective Coating (HRC), in part because HRC efficiency is typically achievable at 99% or higher, there is minimal total reflection loss of less than 0.1 dB in this light path. The planar mirrors 308a and 310a may include mirrors that present a planar reflective surface to incoming light, such as flat mirrors or prism mirrors.

Regardless of the number of channels (i.e., single mode fibers), larger and smaller numbers of channels (fibers in the arrays) are possible as well according to embodiments. Advantageously, since examples of optical connectors described herein are compact, they can be expanded to more channels without imposing as great a device footprint penalty. In addition, although, for each of the lids, a single concave mirror and a single planar mirror is suggested in FIG. 3B, suggesting that mirrors 308a, 308b, 310a and 310b are continuous into the plane of FIG. 3B, embodiments are not so limited, and include within their scope the provision of an array of optical reflective components extending into the plane of FIG. 3B, including, for example, an array of planar mirrors 308a, an array of concave mirrors 308b, an array of planar mirrors 310a and/or an array of concave mirrors 310b.

Referring in particular to FIG. 3B, light beam 318 is shown by way of its optical axis in broken lines as travelling between the inner surfaces of the top lid 304 and bottom lid 306 between the top lid 304 and bottom lid 306 in any direction. Although the description below refers to light travelling from the PIC side to the FAU side, embodiments are not so limited, and provide a configuration of an optical connector that is configured to direct light between a PIC and a FAU in any direction. As seen in FIG. 3B, light beam 318 travels out of fiber optic cable 314 from the PIC 220a, reflecting four times before it couples into the fiber optic cable 312 on the FAU side. When an in-plane lateral offset (an offset in alignment in a horizontal direction) between the top lid 304 and the bottom lid 306 in a plane of the image of FIG. 3B) occurs between the pair of lids 304 and 306, the consequential offset on the first concave mirror 308b, would generate an exact but opposite offset on the second concave mirror 310b, i.e., the symmetrical double-concave mirrors compensating each other's translation in terms of an in plane lateral offset.

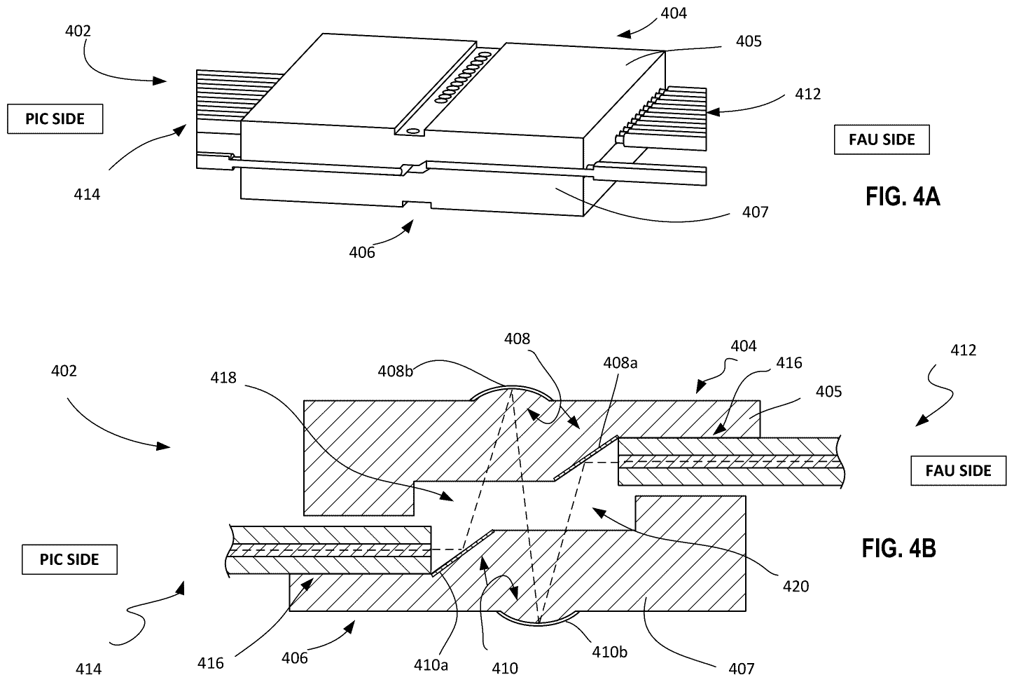

Let us now refer to FIGS. 4A and 4B, which show a second embodiment of a self-locking optical connector, such as a self-locking monolithic detachable optical connector. Like components as between FIGS. 3A and 3B on one hand and FIGS. 4A and 4B on the other hand are referred to with like reference numerals.

FIG. 4A, similar to FIG. 3A, shows a perspective view of a pair of lids 404 and 406 that are in a mating position to for the optical connector 402. FIG. 4B, similar to FIG. 3B, shows a longitudinal cross section through the optical connector 402 of FIG. 4A, depicting a light path therethrough. FIGS. 4A and 4B are generally similar to FIGS. 3A and 3B, except that, in FIGS. 4A and 4B, the concave mirrors 410a and 410b are placed at outer surfaces of the top and bottom lids 404 and 406 rather than at the inner surfaces of the same. Thus the lid body material would be transparent materials in FIGS. 4A and 4B, for example, glass or transparent polymer, etc. The latter configuration of the lids provides an alternative way of implementing distance control and the assembly process. With the help of Anti-Reflective Coating (ARC) and HRC applied on the boundaries between each of the concave “lenses” or concave mirrors 408b and 410b and the material of the respective substrates for top lid 404 and bottom lid 406, typical achievable total reflection loss is less than 0.2 dB.

The top and bottom lids 404 and 406 may include, respectively, a substrate 405/407 made of glass and/or a monolithic substrate. Each of the top lid 404 and bottom lid 406 may be substantially planar at externally facing or outer surfaces thereof (i.e., faces thereof to face externally when the top lid and the bottom lid are in a mated configuration), as shown for example in FIGS. 4A and 4B. The top lid 404 may include reflective micro-optic components 408 that include a planar mirror 408a and a concave mirror 408b fixed to substrate 405 at the outer surface of top lid 404. The bottom lid 406 may include reflective micro-optic components 410 that include a planar mirror 410a and a concave mirror (e.g., micromirror) 410b fixed to substrate 405 at the outer of bottom lid 406. Fiber optic cables 412 and 414 held within grooves 416, along with other components of the optical connector 402, may be similar to corresponding components of FIGS. 3A and 3B.

The reflective micro-optic components 408 and 410 can be, for example, total internal reflection (TIR) mirrors, or alternatively they can be a reflective material, such as a metal, that is a coating attached to inner surfaces of lid substrates 405 and 407. Preferably, all optical reflective components according to some embodiments include a High Reflective Coating (HRC), in part because HRC efficiency is typically achievable at 99% or higher, there is minimal total reflection loss of less than 0.1 dB in this light path. The planar mirrors 408a and 410a may include mirrors that present a planar reflective surface to incoming light, such as flat mirrors or prism mirrors.

Regardless of the number of channels (i.e., single mode fibers), larger and smaller numbers of channels (fibers in the arrays) are possible as well according to embodiments. Advantageously, since examples of optical connectors described herein are compact, they can be expanded to more channels without imposing as great a device footprint penalty. In addition, similar to FIG. 3B, although, for each of the lids, a single concave mirror and a single planar mirror is suggested in FIG. 4B, suggesting that concave mirrors 408a, 408b, 410a and 410b are continuous into the plane of FIG. 4B, embodiments are not so limited, and include within their scope the provision of an array of optical reflective components extending into the plane of FIG. 4B, including, for example, an array of planar mirrors 408a, an array of concave mirrors 408b, an array of planar mirrors 410a and/or an array of concave mirrors 410b.

Referring in particular to FIG. 4B, light beam 418 is shown in broken lines as travelling between the top lid substrate 405 and bottom lid substrate 407 in any direction. In FIG. 4B, light travels through a cavity 420 defined between respective inner facing surfaces of the top lid 304 and the bottom lid 306. The cavity is bounded by surfaces that include the planar mirrors 408a and 410a, and may be an air cavity, or filled with a transparent material, such as glass or epoxy.

As seen in FIG. 4B, light beam 418 travels out of fiber optic cable 414 from the PIC side, reflecting four times before it couples into the fiber optic cable 412 on the FAU side, travelling through the substrate 305 every time before it reaches concave mirror 308b and every time after it is reflected by concave mirror 308b, and further travelling through the substrate 307 every time before it reaches concave mirror 308b and every time after it is reflected by concave mirror 308b. When an in-plane offset (an offset in alignment between the top lid substrate 405 and the bottom lid substrate 407 in a plane of the image of FIG. 4B) occurs between the pair of lid substrates 405 and 407, the consequential offset on the first concave mirror 408b, would generate an exact but opposite offset on the second concave mirror 410b, i.e., the symmetrical double-concave mirrors compensating each other's translation in terms of in planar offset.

For both of the embodiments of FIGS. 3A and 3B, and 4A and 4B, the concave mirrors may include parabolic or toric mirrors. A parabolic mirror is a type of reflective surface that has the shape of a paraboloid, a parabola rotated around its axis. This specific shape gives the parabolic mirror unique optical properties that make it highly effective for focusing or collimating light. This geometric shape ensures that all parallel rays of light entering the mirror are reflected to converge at a single point called the focal point. Conversely, if a point source of light impinges on a parabolic mirror, the light rays emanating from the point source are reflected as parallel rays. This means the parabolic mirror can transform divergent light from a point source into a collimated beam.

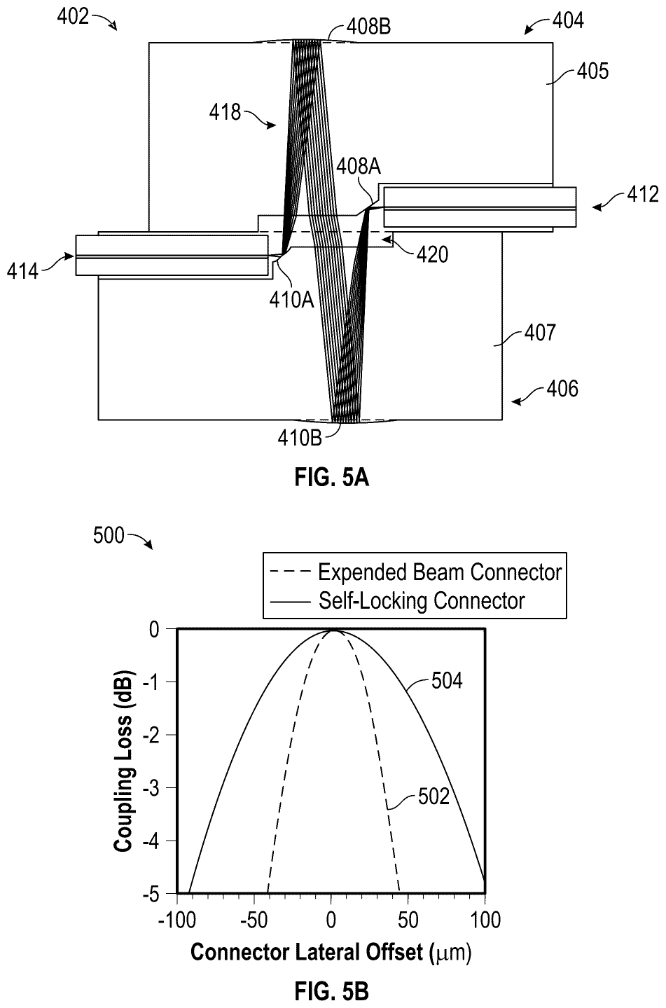

Let us now refer to FIGS. 5A and 5B, which show, respectively, another illustration of the optical connector 402 of FIG. 4B, and a ray tracing graph 500 of the self-locking optical interconnect design in according to the embodiment of FIGS. 4A and 4B. Like components as between FIGS. 4A/4B and 5A are referred to with like reference numerals. As seen in FIG. 5A, light from fiber optic cable 414 emerges into cavity 420, and expands before impinging in prism mirror 410a, upon which it is reflected through cavity 420 and through the material of substrate 405 before impinging on parabolic or toric concave mirror 410b. At parabolic or toric concave mirror 410b, the light is collimated, and travels back through the material of substrate 405, through cavity 420, and through the material of substrate 307 before impinging on parabolic or toric concave mirror 408b, upon which it is reflected to converge toward prism mirror 408a, where it is reflected onto the input of fiber optic cable 412. Beam 418 expands in a parallel fashion between the two parabolic or toric concave mirrors 410b and 408b.

Referring now to FIG. 5B, a graph 500 shows coupling loss in decibels (dBs) plotted against connector lateral offset in microns (μm) for both a conventional expanded beam (EB) optical connector at curve 502 and for a self-locking optical connector according to some embodiments such as the one shown in FIG. 5A at curve 504. For graph 500, the mode field diameter (MFD—width of optical signal in each fiber optic cable) is 80 microns. Graph 500 suggests that a self-locking optical connector according to embodiments can improve the lateral offset tolerance between the top lid and bottom lid by at least two orders of magnitude as compared with conventional EB based connectors with the same MFD, and thus without expanding the beam size. For embodiments where the cavity between the top lid and the bottom lid includes a transparent spacer, such as a glass spacer 422, in addition to the benefits of offset tolerance provided by the self-locking micro-optic components, the transparent spacer in between the two glass sheets can advantageously control the tilt angle between the top lid and the bottom lid during the mating.

### Toric Mirrors

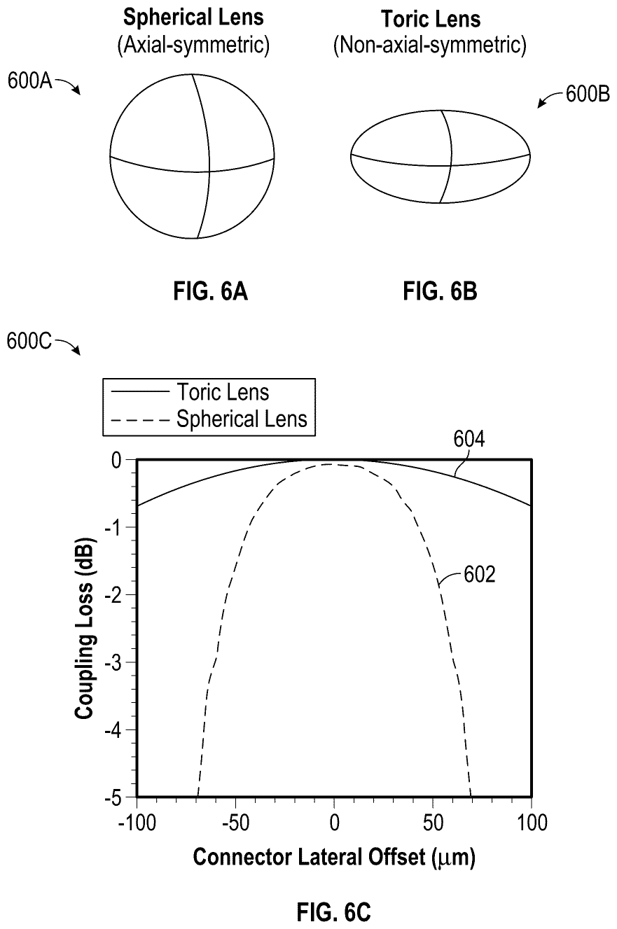

Let us now refer to FIGS. 6A and 6B, which show a spherical mirror shape 600A and a toric mirror shape 600B respectively. According to a preferred embodiments, concave mirrors such as mirrors 308b and 310b of FIG. 3B and concave mirrors 408b and 410b of FIG. 4B, include toric mirrors, similar to that shown in FIG. 6B.

Some embodiments optimize the lens feature/concave mirror feature to include a toric shape instead of a conventional spherical lens. By this optimization, the offset tolerance in the assembling a self-locking optical connector according to some embodiments can be substantially enhanced.

Referring back to FIG. 4B, to maintain a low incidence angle to the concave mirror 408b/410b, it is essential to minimize the horizontal distance between the concave mirror 408b/410b and prism mirror 408a/410a, respectively. An attempt toward the latter minimization is preferable because a large incidence angle on a curved mirror can lead to significant distortions in beam shape, resulting in high coupling loss due to beam mismatch. Consequently, the diameter of the spherical lens must be restricted to very small sizes to prevent the concave mirror and the prism mirror from which the light emanates onto the concave mirror from blocking the optical path.

A lens/concave mirror design employing a toric shape is proposed to address the above issue. Referring again to FIG. 5A, unlike the conventional spherical lens, which is axially symmetric, the toric lens is a type of non-axial-symmetric lens with different radii of curvature along two orthogonal axes. This special lens shape compensates for beam distortion caused by larger incidence angles, thereby overcoming the limitations on lens diameter imposed by traditional spherical lenses.

According to embodiments, where the concave mirror of a lid of an optical connector has a toric shape, the concave mirror is disposed on the lid such that its longest axis (i.e., its “long axis) extends in a coupling direction of the light beam through the optical connector. That is, if an optical connector according to some embodiments is to couple light from one end thereof (e.g., in FIG. 3B or FIG. 4B, from the PIC side) to another end thereof (e.g., in FIG. 3B or FIG. 4B, to the FAU side), the longest axis of the toric concave mirror extends in a direction from said one end to said another end (e.g., in FIG. 3B or FIG. 4B, in a horizontal direction from the PIC side to the FAU side).

The offset tolerance comparison between using the conventional spherical lens shape and the novel toric lens shape is shown by way of graph 600C in FIG. 6C. Both designs utilize a mode field diameters (MFDs) of 110 μm. However, as depicted in FIG. 6C, the conventional spherical lens's limitation on diameter significantly restricts offset tolerance due to the aperture effect of the spherical mirror. In contrast, the toric lens design enhances offset tolerance, especially with larger lateral offsets as between the concave mirror and its opposing planar mirror, as illustrated in the comparison chart. This improvement is substantial, demonstrating the efficacy of the toric lens in maintaining performance despite increased incidence angles and lateral misalignments.

By employing the toric lens design, some embodiments achieve a considerable enhancement in offset tolerance without the constraints of traditional spherical lenses. This advancement allows for larger lens diameters and improved performance in optical systems where maintaining low incidence angles and minimizing beam distortion are critical.

### Mechanism of Optical Self-Locking

The dual-concave-mirror vertical optical connector in embodiments has a unique optical design that enables optical self-locking. Specifically, some embodiments can achieve a lateral offset tolerance of over 100 μm (with target of −1 dB sensitivity loss), which is significantly greater than that of traditional dual-concave-mirror vertical optical connectors. The principle of optical self-locking according to embodiments is described as follows.

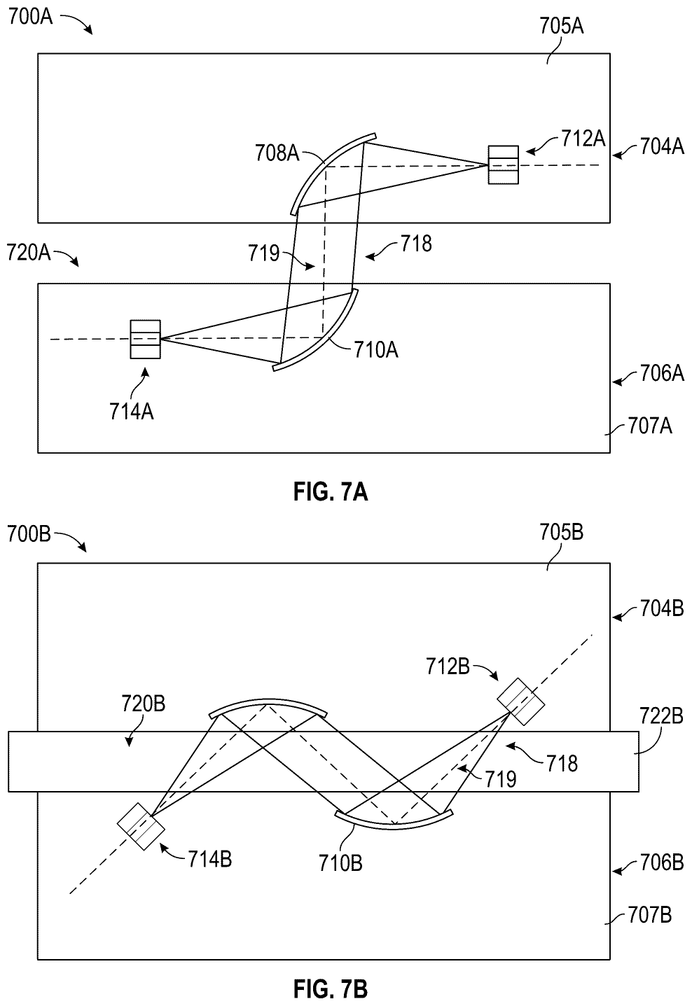

Let us first refer to FIGS. 7A and 7B. FIG. 7A shows an exemplary configuration of a conventional dual-concave-mirror vertical optical connector 700A. FIG. 7B shows an embodiment of a self-locking optical connector 700B comparable to that of FIG. 3B. Optical connector 700A/700B includes a top lid 704A/704B having a substrate 705A/705B, and a bottom lid 706A/706B having substrates 707A/707B. Top lid 704A/704B is configured to secure a fiber optic cable 712A/712B therein on an FAU side thereof, and bottom lid 706A/706B is configured to secure a fiber optic cable 714A/714B therein on a PIC side thereof. A concave mirror 708A/708B is embedded within substrate 705A/705B, and a concave mirror 710A/710B is embedded within substrate 707A/707B. The optical connector 700A/700B defines a cavity 720A/720B between lids 704A/704B and 706A/706B. In the embodiment of FIG. 7B, the optical connector 702B includes a glass spacer 722B within cavity 720B.

In FIG. 7A, light beam 718 defining optical axis 719 (shown in broken lines, which show various straight linear portions corresponding to respective straight linear optical axis of light beam 718) travels from fiber optic cable 714A, impinges on concave mirror 710A, is collimated in its travel through cavity 720A to impinge on concave mirror 708A before it is reflected by being focused toward fiber optic cable 712A, manner coupling the PIC to the FAU.

On the other hand, in FIG. 7B, light beam 718 defining optical axis (shown in broken lines, which show various straight linear portions corresponding to respective straight linear optical axis of light beam 718) travels from fiber optic cable 714B secured at the bottom lid 706B, impinges onto concave mirror 708B of the top lid 704B, as a result of which it is collimated as it moves toward concave mirror 710B embedded in the bottom lid 706B before being reflected and focused by concave mirror 710B toward the fiber optic cable 712B secured by the top lid 704B. Similar to the embodiment of FIG. 3B, light beam 718 in the embodiment of FIG. 7B, the structure of the optical connector is such that: (1) a first concave mirror in the path of light emanating from a fiber optic cable secured by one of the lids is embedded in an opposing one of the lids; and (2) a last concave mirror on the path of light toward a fiber optic cable secured by one of the lids is embedded in an opposing one of the lids.

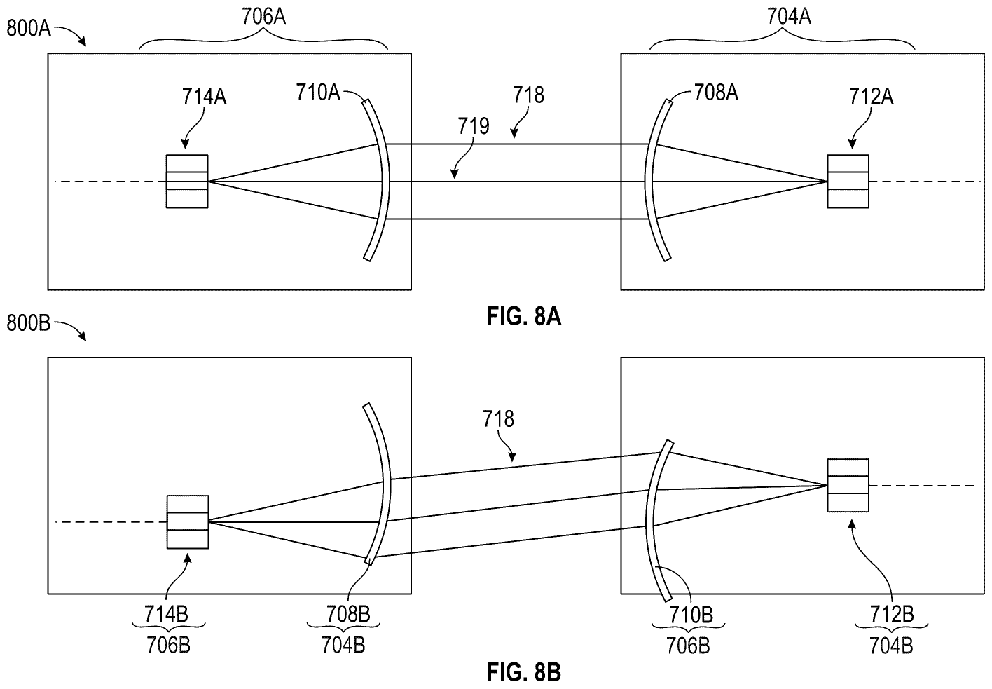

Considering a deconstructed version of the optical path diagrams in FIG. 7A makes it evident that the structure of FIG. 7A is equivalent to the dual-convex-mirror optical connector 800A of FIG. 8A. By deconstructing the optical path diagrams in FIG. 7B, it is evident that this structure is equivalent to the dual-convex-mirror optical connector 800A of FIGS. 8B, which correspond to an embodiment of a self-locking dual-convex-mirror optical connector. Geometrically deconstructing the optical path diagrams of FIGS. 7A and 7B to result in respective equivalent configurations in FIGS. 8A and 8B helps to better reveal the operation of a self-locking connection according to some embodiments. In FIGS. 8A and 8B, like components as compared with, respectively, FIGS. 7A and 7B are referred to with like reference numerals.

Referring to FIG. 8A, the figure shows an equivalent optical path diagram of the dual-convex-mirror optical connector 800A corresponding to the conventional optical connector 700A of FIG. 7A, shows fiber optic cable 714A as a source of light beam 718 that is reflected by concave mirror 710A, with both fiber optic cable 714A and concave mirror 710A being on a same lid, the bottom lid 706A. As already explained with respect to FIG. 7A, concave mirror 710A collimates the light beam 718 and directs it toward concave mirror 708A on the opposing lid, the top lid 704A, which focuses it toward fiber optic cable 712A on same top lid 704A.

Enhancement of the lateral offset tolerance between top and bottom glasses in the traditional double-concave mirror vertical optical connector as shown in FIG. 7A and equivalently in FIG. 8A may be achieved through an expanded beam size (e.g., a higher MFD). Thus, to enable a conventional design such as that of FIGS. 7A/8A to achieve a lateral tolerance of more than 100 μm, the expanded beam size would need to be at least 400 μm. The latter is clearly impractical, as such a large beam size would make the coupling loss significantly sensitive to the beam tilt angle and would also significantly increase the pitch size in fiber optic cable arrays, thereby reducing the compactness of the package.

Referring to FIG. 8B, equivalent optical path diagram showing dual-convex-mirror optical connector 800B corresponding to the self-locking optical connector 700B of FIG. 7B according to an embodiment. FIG. 8B shows fiber optic cable 714B as a source of light beam 718 that is reflected by concave mirror 708B, with the fiber optic cable 714B and concave mirror 708B being on opposing lids, the bottom lid 706B and the top lid 704B, respectively. As already explained with respect to FIG. 7B, concave mirror 708B collimates the light beam 718 and directs it toward concave mirror 710B on the opposing lid, the bottom lid 706B, which focuses it toward fiber optic cable 712B on same top lid 704B.

By comparing the equivalent structure of a dual-convex-mirror optical connector 800B of the self-locking vertical optical connector with the equivalent structure of a dual-convex-mirror optical connector 800A of the traditional vertical optical connector, a difference that emerges is that the fiber optic cable 714B of bottom lid 706B and concave mirror 710B of bottom lid 706B in a self-locking optical connector are on the same structure, substrate 707B (of bottom lid 706B), and, therefore, they will necessarily move together during any lateral shifts. Therefore, if there is a deflection in the light beam path due to lateral offset between fiber optic cable 714B and concave mirror 710B, an equal and opposite deflection will occur because of the offset between fiber optic cable 712B and concave mirror 708B. This action guarantees that the light beam remains precisely focused on fiber optic cable 712B, irrespective of the lateral offset's magnitude. It is evident that this self-locking design establishes an optical connection between the top and bottom glasses, ensuring that the symmetry of the optical system is not broken even when a lateral offset occurs, thereby achieving a high lateral offset tolerance.

Through the optical self-locking mechanism of embodiments, the lateral offset tolerance can be enhanced without relying on expended beam size. As shown in FIGS. 7B and 8B, a difference between the self-locking vertical optical connector and the traditional vertical optical connector is that the optical beams are collimated through the concave mirror on the opposite substrate. For example, a light beam emitting from a fiber secured in one lid will first be collimated by a concave mirror on the opposite lid and then converged back to the one lid by the concave mirror on the opposite lid, and vice versa. In this manner, a unique optical and geometric connection is created between the two lids. The implementation of the Self-locking Monolithic Detachable Optical connector targets both alignment accuracy for optimal optical performance and manufacturing scalability for business feasibility. As discussed in preceding sections, the self-locking mechanism necessitates the integration of multiple micro-optic components, such as reflective prisms and curved mirrors, configured in specific geometric relationships. To fulfill these requirements, embodiments employ glass-based molding techniques.

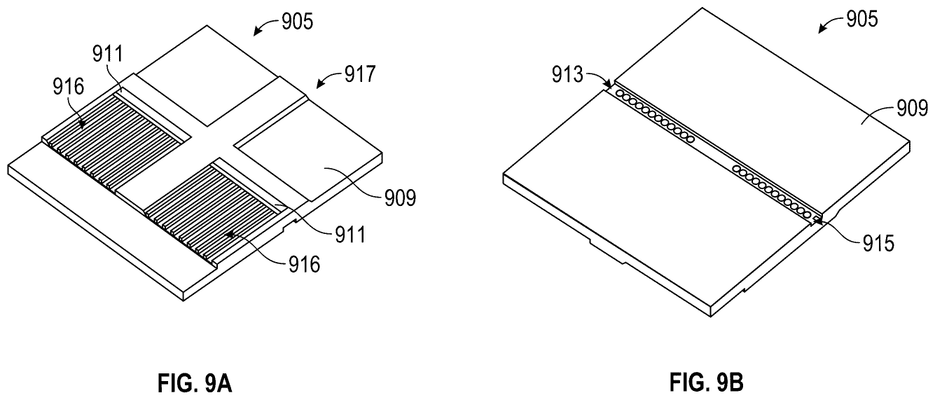

FIGS. 9A and 9B show perspective views of a self-locking lid 905 (e.g., either top lid 404 or bottom lid 406 of FIGS. 4A and 4B) of an optical connector according to some embodiments. FIG. 9A shows a top side or inner surface of lid 905, and FIG. 9B shows the outer surface of lid 905. In the embodiment of FIGS. 9A and 9B, the lid 905 includes a monolithic glass substrate 909, where the glass of the substrate 909 integrates all features into one body, including prism mirrors 911, concave mirrors 913 disposed within recess 915, spacers 917, and fiber grooves 916. This integration simplifies the assembly processes and improves optical performance and product scalability.

Although the description herein refers to light travelling from the PIC side to the FAU side, embodiments are not so limited, and provide a configuration of an optical connector that is configured to direct light between two optical devices, such as between a PIC and an FAU, between two PICs (e.g., on a same package), or between two FAUs, in any direction. In addition, one of the lid may be part of the silicon (or integrated into a PIC), while the other lid is external to the silicon, thus forming a connector pair between PIC waveguide and external fibers. (if this description in fact is redundant to next paragraph please remove it).

Although the description herein shows examples where a self-locking optical assembly includes or may be configured to include fiber optic cables, embodiments are not so limited, and include within their scope the provision of an optical connector that is configured to be directly coupled on at least one of its input side or its output side to a PIC waveguide without the intermediary of fiber optic cable arrays.

For all embodiments expressly described herein, such as for both of the embodiments of FIGS. 3A and 3B, and 4A and 4B, although a single fiber optic cable 312, 314, 412 and 414 may have been shown and mentioned, it is understood that a “fiber optic cable” as mentioned herein could include one or more fiber optic cables, such as an array of fiber optic cables. The type of fiber optic cables can include, by way of example, single mode optical fibers (SMF), polarization maintenance fiber (PMF), or multimode fibers (MMF).

In the context of embodiments, an optical connector kit according to some embodiments includes a top lid (such as top lid/lid 304/404/704B/905 described above) and a bottom lid (such as bottom lid/lid 306/406/706B/905 described above), where individual ones of the top lid and the bottom lid that are configured to mate together to form an optical connector configured such that a light beam emitting from the bottom lid toward the top lid is first collimated by a concave mirror on the top lid, and such that a light beam collimated by the concave mirror on the top lid is first focused by a concave mirror on the bottom lid back toward the top lid. According to some embodiments, the top lid and the bottom lid are identical to each other. According to another embodiment, the top lid and the bottom lid are different with respect to each other. For example, according to some embodiments, one of the lids includes alignment features on an outer surface thereof while the other does not. According to yet another embodiment, one of the two lids includes a concave mirror at an inner surface thereof (similar for example to top lid 304 or bottom lid 306 of FIG. 3B) and another one of the two lids includes either: (a) a concave mirror disposed at the outer surface thereof (similar for example to top lid 404 or bottom lid 406 of FIG. 4B); or (b) a concave mirror embedded within the substrate thereof (similar for example to top lid 704B or bottom lid 706B of FIG. 7B). According to yet another embodiment, one of the two lids includes a concave mirror disposed at the outer surface thereof (similar for example to top lid 404 or bottom lid 406 of FIG. 4B) and another one of the two lids includes a concave mirror embedded within the substrate thereof (similar for example to top lid 704B or bottom lid 706B of FIG. 7B). According to yet another embodiment, one of the two lids includes part of the silicon (or is integrated into a PIC), while the other lid is an external body to the silicon, two of which forming a connector pair between PIC waveguide and external fibers.

Self-Locking Monolithic Connector Made from Scalable Manufacturing Process

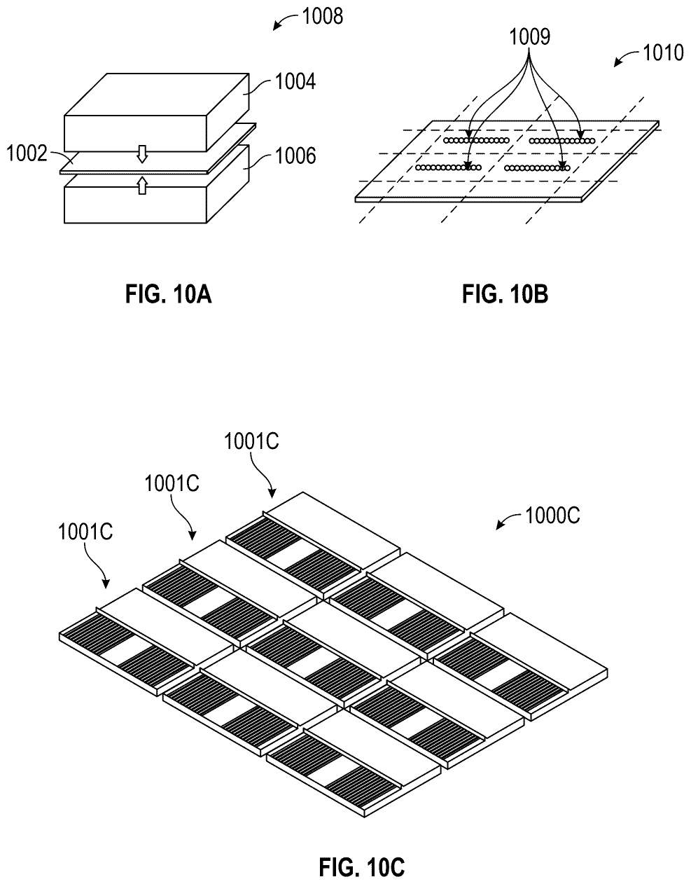

Referring now to FIGS. 10A-10C, a self-locking lid for an optical connector may be made through a molding process, followed by a cutting or singulation process.

Referring to FIG. 10A, a molding process according to some embodiments includes molding sheet glass 1002 within plates 1004 and 1006 of a molding tool 1008. For a self-locking monolithic optical connector according to some embodiments, glass molding facilitates the integration of optical elements, fiber grooves, alignment features, and mechanical features into a cohesive, unibody structure. The latter minimizes potential misalignment issues from multiple components during assembly processes, improves assembly efficiency, and enhances product scalability.

A molding process as depicted in FIG. 10A results in a panel of lid substrates.

FIG. 10B shows a perspective view of a panel 1010 of lid substrates 1009, for example after the molding process of FIG. 10B. The panel 1010 of FIG. 10B may be subjected to a cutting or singulation process as suggested by the broken lines seen in FIG. 10B.

FIG. 10C shows a matrix 1000C of monolithic lids 1001C for an optical connector according to some embodiments, depicting an example after panel-level molding and cutting processes.

There are some main advantages of sheet glass-based manufacturing. First, different features are created in the same process, providing exceptional positional control compared to multiple assembled components and reducing assembly costs. Second, the glass unibody design enables reflow compatibility and eliminates material interfaces and epoxy dispense processes that could lead to reflow failures. Next, sheet glass supports panel operations, including molding and cutting, ensuring quality and consistency. Finally, glass molding at the panel level offers high throughput, allowing for easy scalability and high-volume production.

Advantageously, a detachable optical connector employs a unique self-locking optical design that relaxes offset tolerances without relying on expanding beams (EB). Compared to conventional EB-based optical connectors, some embodiments advantageously offer significant benefits. For example, some embodiments substantially eliminate the offset-tilting tolerance trade-off inherent in traditional EB optical connectors by virtue of a unique self-locking mechanism. Some embodiments can achieve 2 to 3 times better offset alignment tolerance between a top lid and a bottom lid of an optical connector without tightening the requirement for tilting tolerance. Additionally, some embodiments advantageously enable pitch reduction as between fiber optic cables for scaling because a large mode field diameter (MFD) is no longer required to relax alignment tolerance; instead, accurate alignment is maintained by the self-locking mechanism.

Moreover, according to some embodiments, the optical connector features a novel toric concave mirror/mirror (non-axial-symmetric) shape instead of the conventional spherical mirror shape (axial-symmetric). This design substantially improves lateral offset tolerance by compensating for beam distortion. According to some embodiments, integration of micro-optic components, such as prisms and lenses, into a monolithic glass lid eliminates boundaries among these components, thus releasing the alignment accuracy requirement during lid assembly. With fewer standalone components, an optical connector fabrication process flow according to some embodiments is better streamlined, reducing assembly complexity, and simplifying alignment feature design.

Some embodiments include an optical connector of a semiconductor assembly. Referring to FIGS. 3A and 3B by way of example only, the optical connector may include a first lid (e.g., top lid 304); and a second lid (e.g., bottom lid 306) attached to the first lid to define a cavity (e.g., cavity 320) therebetween. Individual ones of the first lid and the second lid may include a substrate (e.g., substrate 305 of top lid 304, or substrate 307 of bottom lid 306) having an inner surface facing the cavity, an outer surface opposite the inner surface. The substrate may include first end (e.g., the end 333 of top lid 304 that is to receive fiber optic cable 312 therein, or the end 335 of bottom lid 306 that is to receive fiber optic cable 314 therein) and a second end (e.g., the end 333 of top lid 304 opposite first end 333 of top lid 304, or the end 337 of bottom lid 306 opposite first end 335 of bottom lid 306), the first end to receive a corresponding waveguide therein (e.g., first end 331 is shown as having received a waveguide in the form of fiber optic cable 312, and first end 335 is shown as having received a waveguide in the form of fiber optic cable 314). Individual ones of the first lid and the second lid further include a concave mirror (e.g., concave mirror 308b of top lid 304, or concave mirror 310b of bottom lid 306) on the substrate (e.g., substrate 305 of top lid 304, or substrate 307 of bottom lid 306) and having a reflective surface facing the cavity (e.g., concave mirrors 308b and 310b of FIG. 3B have reflective surfaces that face cavity 320), wherein a straight linear optical axis (e.g., portion of light beam 318 extending between photonic structure in the form of planar mirror 310a of bottom lid 306 and concave mirror 308b of top lid 304; or portion of light beam 318 extending between concave mirror 310b of bottom lid 306 and photonic structure in the form of planar mirror 308a 308b of top lid 304); is to extend between the reflective surface of the concave mirror (e.g., the reflective surface of concave mirror 308b of top lid 304, or the reflective surface of concave mirror 310b of bottom lid 306) and the photonic structure (e.g., the photonic structures in the form of planar mirrors 308a and 310a) at an opposing one of said individual ones of the first lid and the second lid (e.g., portion of light beam 318 extending between planar mirror 310a of bottom lid 306 and concave mirror 308b of top lid 304 extends between opposing lids; and or portion of light beam 318 extending between concave mirror 310b of bottom lid 306 and planar mirror 308a and 308b of top lid 304 also extends between opposing lids). Referring to FIG. 7B by way of example, the photonic structures can also include the waveguides/fiber optic cables 712B and 714B themselves, which may be oriented to direct the optical axis to intersect the opposing concave mirrors 710B and 708B, respectively.

Advantageously, some embodiments substantially improve performance through scalable manufacturing for CPO interconnects, promoting optics adaptation at the package level. A unique self-locking optical design according to some embodiments advantageously relaxes offset tolerance without relying on an expanding beam (EB). Compared to conventional EB-based couplers, some embodiments eliminate the offset tilting-tolerance trade-off of traditional EB connectors, achieving 2 to 3 times better offset alignment tolerance without tightening the tilting tolerance requirement. Additionally, some embodiments enable pitch reduction for scaling, as the large mode field diameter (MFD) associated with EB is no longer required to relax alignment tolerance. According to embodiments, accurate alignment is maintained by the self-locking mechanism.

Regarding FIGS. 3A-3B and FIGS. 4A-4B, a person skilled in the art would appreciate that besides v-grooves, other structural features may be used to secure the fiber optic cables, such as holes, blind holes, u-grooves, grooves of any other shape, by way of example.

A fiber optic cable as described herein may include any appropriate fiber optic cable as would be recognized by a person skilled in the art, such as a single mode fiber optic cable, a polarization maintaining fiber optic cable, or a multi-mode fiber optic cable.

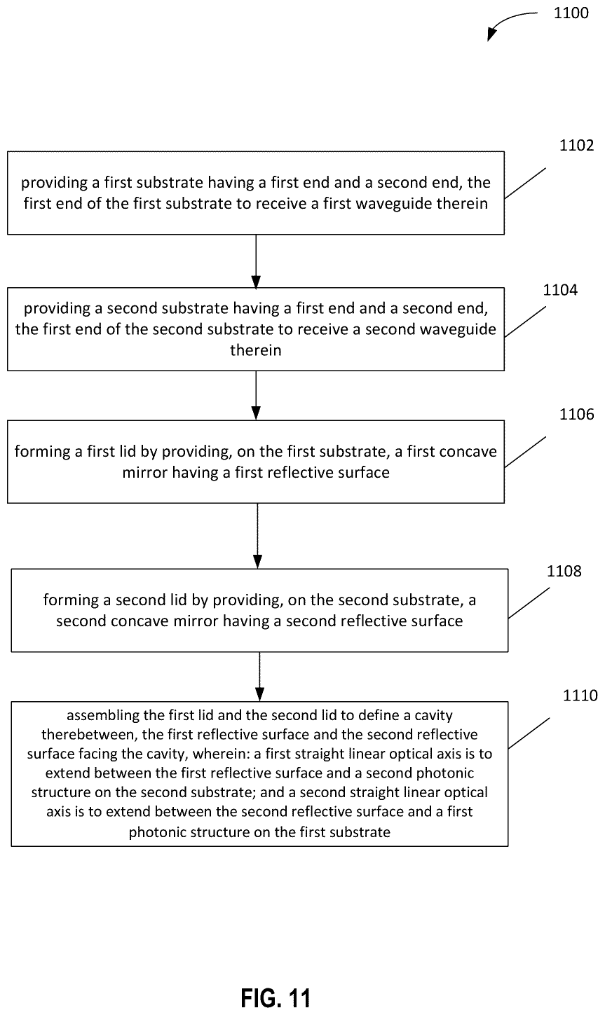

FIG. 11 is a flowchart of a process 1100 according to some embodiments. At operation 1102, the process includes providing a first substrate having a first end and a second end, the first end of the first substrate to receive a first waveguide therein. At operation 1104, the process includes providing a second substrate having a first end and a second end, the first end of the second substrate to receive a second waveguide therein. At operation 1106, the process includes forming a first lid by providing, on the first substrate, a first concave mirror having a first reflective surface. At operation 1108, the process includes forming a second lid by providing, on the second substrate, a second concave mirror having a second reflective surface. At operation 1110, the process includes assembling the first lid and the second lid to define a cavity therebetween, the first reflective surface and the second reflective surface facing the cavity, wherein: a first straight linear optical axis is to extend between the first reflective surface and a second photonic structure on the second substrate; and a second straight linear optical axis is to extend between the second reflective surface and a first photonic structure on the first substrate.

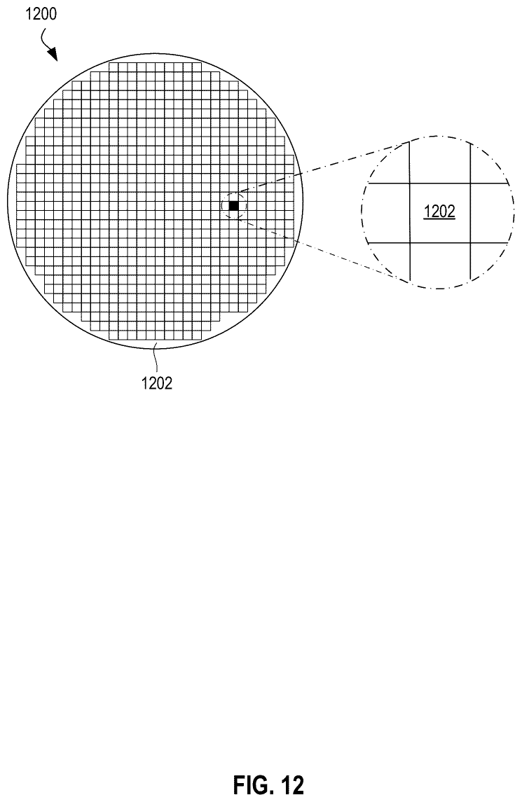

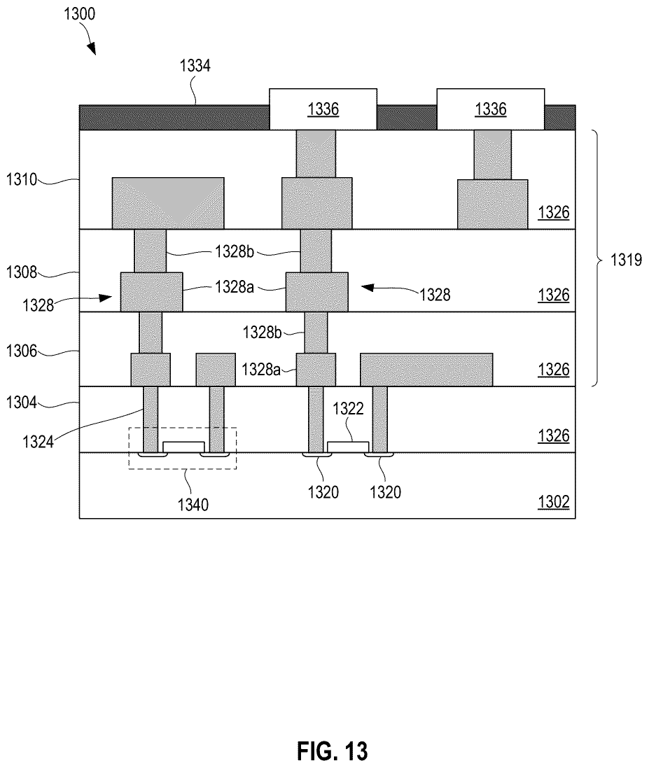

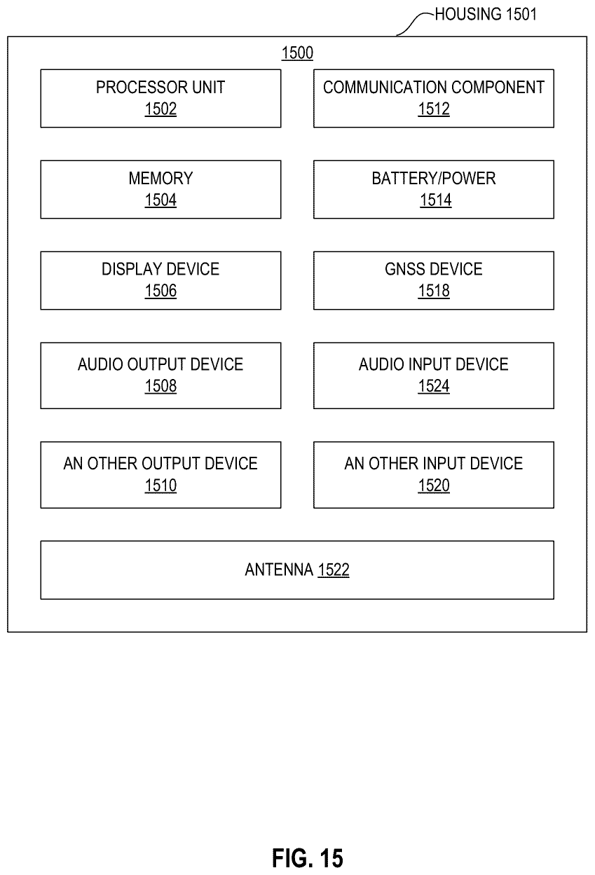

FIG. 12 is a top view of a wafer 1200 and dies 1202 that may be included in any of the embodiments disclosed herein. The wafer 1200 may be composed of semiconductor material and may include one or more dies 1202 formed on a surface of the wafer 1200. After the fabrication of the integrated circuit components on the wafer 1200 is complete, the wafer 1200 may undergo a singulation process in which the dies 1202 are separated from one another to provide discrete “chips” or destined for a packaged integrated circuit component. The individual dies 1202, comprising an integrated circuit component, may include one or more transistors (e.g., some of the transistors 1340 of FIG. 13, discussed below), supporting circuitry to route electrical signals to the transistors, passive components (e.g., signal traces, resistors, capacitors, or inductors), and/or any other integrated circuit components. In some embodiments, the wafer 1200 or the die 1202 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 1202. For example, a memory array formed by multiple memory devices may be formed on a same die 1202 as a processor unit (e.g., the processor unit 1502 of FIG. 15) or other logic that is configured to store information in the memory devices or execute instructions stored in the memory array. In some embodiments, a die 1202 may be attached to a wafer 1200 that includes other die, and the wafer 1200 is subsequently singulated, this manufacturing procedure is referred to as a die-to-wafer assembly technique.

FIG. 13 is a cross-sectional side view of an integrated circuit 1300 that may be included in any of the embodiments disclosed herein. One or more of the integrated circuits 1300 may be included in one or more dies 1202 (FIG. 12). The integrated circuit 1300 may be formed on a die substrate 1302 (e.g., the wafer 1200 of FIG. 12) and may be included in a die (e.g., the die 1202 of FIG. 12).

The die substrate 1302 may be a semiconductor substrate composed of semiconductor material systems including, for example, n-type or p-type materials systems (or a combination of both). The die substrate 1302 may include, for example, a crystalline substrate formed using a bulk silicon or a silicon-on-insulator (SOI) substructure. In some embodiments, the die substrate 1302 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1302. Although a few examples of materials from which the die substrate 1302 may be formed are described here, any material that may serve as a foundation for an integrated circuit 1300 may be used. The die substrate 1302 may be part of a singulated die (e.g., the dies 1202 of FIG. 12) or a wafer (e.g., the wafer 1200 of FIG. 12).

The integrated circuit 1300 may include one or more device layers 1304 disposed on the die substrate 1302. The device layer 1304 may include features of one or more transistors 1340 (e.g., metal oxide semiconductor field-effect transistors (MOSFETs)) formed on the die substrate 1302. The transistors 1340 may include, for example, one or more source and/or drain (S/D) regions 1320, a gate 1322 to control current flow between the S/D regions 1320, and one or more S/D contacts 1324 to route electrical signals to/from the S/D regions 1320.

The gate 1322 may be formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1340 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1340 along the source-channel-drain direction, the gate electrode may consist of a U-shaped structure that includes a bottom portion substantially parallel to the surface of the die substrate 1302 and two sidewall portions that are substantially perpendicular to the top surface of the die substrate 1302. In other embodiments, at least one of the metal layers that form the gate electrode may simply be a planar layer that is substantially parallel to the top surface of the die substrate 1302 and does not include sidewall portions substantially perpendicular to the top surface of the die substrate 1302. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1320 may be formed within the die substrate 1302 adjacent to the gate 1322 of individual transistors 1340. The S/D regions 1320 may be formed using an implantation/diffusion process or an etching/deposition process, for example. In the former process, dopants such as boron, aluminum, antimony, phosphorous, or arsenic may be ion-implanted into the die substrate 1302 to form the S/D regions 1320. An annealing process that activates the dopants and causes them to diffuse farther into the die substrate 1302 may follow the ion-implantation process. In the latter process, the die substrate 1302 may first be etched to form recesses at the locations of the S/D regions 1320. An epitaxial deposition process may then be carried out to fill the recesses with material that is used to fabricate the S/D regions 1320. In some implementations, the S/D regions 1320 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1320 may be formed using one or more alternate semiconductor materials such as germanium or a group III-V material or alloy. In further embodiments, one or more layers of metal and/or metal alloys may be used to form the S/D regions 1320.

Electrical signals, such as power and/or input/output (I/O) signals, may be routed to and/or from the devices (e.g., transistors 1340) of the device layer 1304 through one or more interconnect layers disposed on the device layer 1304 (illustrated in FIG. 13 as interconnect layers 1306-1310). For example, electrically conductive features of the device layer 1304 (e.g., the gate 1322 and the S/D contacts 1324) may be electrically coupled with the interconnect structures 1328 of the interconnect layers 1306-1310. The one or more interconnect layers 1306-1310 may form a metallization stack (also referred to as an “ILD stack”) 1319 of the integrated circuit 1300.

The interconnect structures 1328 may be arranged within the interconnect layers 1306-1310 to route electrical signals according to a wide variety of designs; in particular, the arrangement is not limited to the particular configuration of interconnect structures 1328 depicted in FIG. 13. Although a particular number of interconnect layers 1306-1310 is depicted in FIG. 13, embodiments of the present disclosure include integrated circuits having more or fewer interconnect layers than depicted.

In some embodiments, the interconnect structures 1328 may include interconnect structures 1328a and/or vias 1328b filled with an electrically conductive material such as a metal. The interconnect structures 1328a may be arranged to route electrical signals in a direction of a plane that is substantially parallel with a surface of the die substrate 1302 upon which the device layer 1304 is formed. For example, the interconnect structures 1328a may route electrical signals in a direction in and out of the page and/or in a direction across the page. The vias 1328b may be arranged to route electrical signals in a direction of a plane that is substantially perpendicular to the surface of the die substrate 1302 upon which the device layer 1304 is formed. In some embodiments, the vias 1328b may electrically couple interconnect structures 1328a of different interconnect layers 1306-1310 together.

The interconnect layers 1306-1310 may include a dielectric material 1326 disposed between the interconnect structures 1328, as shown in FIG. 13. In some embodiments, dielectric material 1326 disposed between the interconnect structures 1328 in different ones of the interconnect layers 1306-1310 may have different compositions; in other embodiments, the composition of the dielectric material 1326 between different interconnect layers 1306-1310 may be the same. The device layer 1304 may include a dielectric material 1326 disposed between the transistors 1340 and a bottom layer of the metallization stack as well. The dielectric material 1326 included in the device layer 1304 may have a different composition than the dielectric material 1326 included in the interconnect layers 1306-1310; in other embodiments, the composition of the dielectric material 1326 in the device layer 1304 may be the same as a dielectric material 1326 included in any one of the interconnect layers 1306-1310.

A first interconnect layer 1306 (referred to as Metal 1 or “M1”) may be formed directly on the device layer 1304. In some embodiments, the first interconnect layer 1306 may include interconnect structures 1328a and/or vias 1328b, as shown. The interconnect structures 1328a of the first interconnect layer 1306 may be coupled with contacts (e.g., the S/D contacts 1324) of the device layer 1304. The vias 1328b of the first interconnect layer 1306 may be coupled with the interconnect structures 1328a of a second interconnect layer 1308.

The second interconnect layer 1308 (referred to as Metal 2 or “M2”) may be formed directly on the first interconnect layer 1306. In some embodiments, the second interconnect layer 1308 may include via 1328b to couple the interconnect structures 1328 of the second interconnect layer 1308 with the interconnect structures 1328a of a third interconnect layer 1310. Although the interconnect structures 1328a and the vias 1328b are structurally delineated with a line within individual interconnect layers for the sake of clarity, the interconnect structures 1328a and the vias 1328b may be structurally and/or materially contiguous (e.g., simultaneously filled during a dual-damascene process) in some embodiments.

The third interconnect layer 1310 (referred to as Metal 3 or “M3”) (and additional interconnect layers, as desired) may be formed in succession on the second interconnect layer 1308 according to similar techniques and configurations described in connection with the second interconnect layer 1308 or the first interconnect layer 1306. In some embodiments, the interconnect layers that are “higher up” in the metallization stack 1319 in the integrated circuit 1300 (i.e., farther away from the device layer 1304) may be thicker that the interconnect layers that are lower in the metallization stack 1319, with interconnect structures 1328a and vias 1328b in the higher interconnect layers being thicker than those in the lower interconnect layers.

The integrated circuit 1300 may include a solder resist material 1334 (e.g., polyimide or similar material) and one or more conductive contacts 1336 formed on the interconnect layers 1306-1310. In FIG. 13, the conductive contacts 1336 are illustrated as taking the form of bond pads. The conductive contacts 1336 may be electrically coupled with the interconnect structures 1328 and configured to route the electrical signals of the transistor(s) 1340 to external devices. For example, solder bonds may be formed on the one or more conductive contacts 1336 to mechanically and/or electrically couple an integrated circuit die including the integrated circuit 1300 with another component (e.g., a printed circuit board). The integrated circuit 1300 may include additional or alternate structures to route the electrical signals from the interconnect layers 1306-1310; for example, the conductive contacts 1336 may include other analogous features (e.g., posts) that route the electrical signals to external components.

In some embodiments in which the integrated circuit 1300 is a double-sided die, the integrated circuit 1300 may include another metallization stack (not shown) on the opposite side of the device layer(s) 1304. This metallization stack may include multiple interconnect layers as discussed above with reference to the interconnect layers 1306-1310, to provide conductive pathways (e.g., including conductive lines and vias) between the device layer(s) 1304 and additional conductive contacts (not shown) on the opposite side of the integrated circuit 1300 from the conductive contacts 1336.

In other embodiments in which the integrated circuit 1300 is a double-sided die, the integrated circuit 1300 may include one or more through silicon vias (TSVs) through the die substrate 1302; these TSVs may make contact with the device layer(s) 1304, and may provide conductive pathways between the device layer(s) 1304 and additional conductive contacts (not shown) on the opposite side of the integrated circuit 1300 from the conductive contacts 1336. In some embodiments, TSVs extending through the substrate can be used for routing power and ground signals from conductive contacts on the opposite side of the integrated circuit 1300 from the conductive contacts 1336 to the transistors 1340 and any other components integrated into the integrated circuit 1300, and the metallization stack 1319 can be used to route I/O signals from the conductive contacts 1336 to transistors 1340 and any other components integrated into the integrated circuit 1300.

Multiple integrated circuits 1300 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

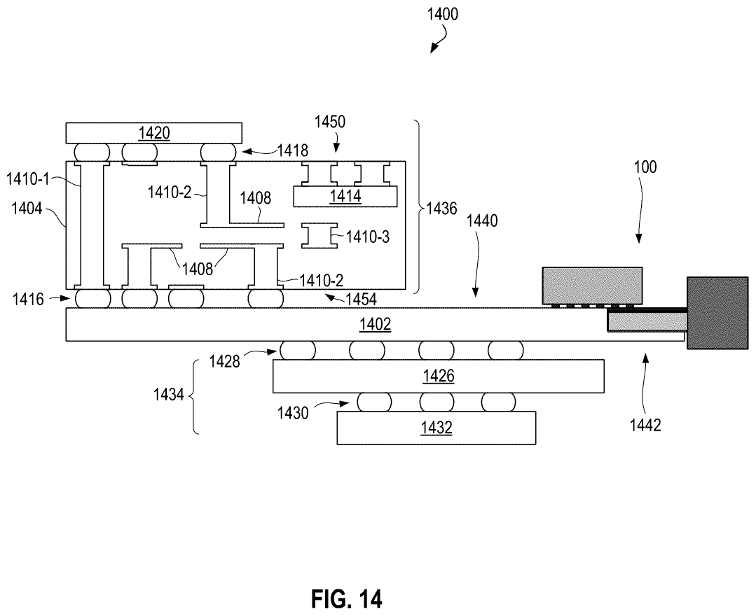

FIG. 14 is a cross-sectional side view of a semiconductor multi-chip package 1400 that may include any of the embodiments disclosed herein. The multi-chip package 1400 includes multiple semiconductor components disposed on a package substrate or circuit board 1402 (which may be a motherboard, system board, mainboard, etc.). The multi-chip package 1400 represents another embodiment of the semiconductor assembly 100 of FIG. 1, and circuit board 1402 may correspond to a package substrate similar to package substrate 122 of FIG. 1, by way of example.

The multi-chip package 1400 may include components disposed on a first face 1440 of the circuit board 1402 and an opposing second face 1442 of the circuit board 1402; generally, components may be disposed on one or both faces 1440 and 1442.

In some embodiments, the circuit board 1402 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1402. In other embodiments, the circuit board 1402 may be a non-PCB substrate. The multi-chip package 1400 illustrated in FIG. 14 includes a package-on-interposer structure 1436 coupled to the first face 1440 of the circuit board 1402 by coupling components 1416. The coupling components 1416 may electrically and mechanically couple the package-on-interposer structure 1436 to the circuit board 1402, and may include solder balls (as shown in FIG. 14), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1436 may include an integrated circuit component 1420 coupled to an interposer 1404 by coupling components 1418. The coupling components 1418 may take any suitable form for the application, such as the forms discussed above with reference to the coupling components 1416. Although a single integrated circuit component 1420 is shown in FIG. 14, multiple integrated circuit components may be coupled to the interposer 1404; indeed, additional interposers may be coupled to the interposer 1404. The interposer 1404 may provide an intervening substrate used to bridge the circuit board 1402 and the integrated circuit component 1420.

The integrated circuit component 1420 may be a packaged or unpackaged integrated circuit component that includes one or more integrated circuit dies (e.g., the die 1202 of FIG. 12, the integrated circuit 1300 of FIG. 13) and/or one or more other suitable components.

The unpackaged integrated circuit component 1420 comprises solder bumps attached to contacts on the die. The solder bumps allow the die to be directly attached to the interposer 1404. In embodiments where the integrated circuit component 1420 comprises multiple integrated circuit dies, the dies can be of the same type (a homogeneous multi-die integrated circuit component) or of two or more different types (a heterogeneous multi-die integrated circuit component). In addition to comprising one or more processor units, the integrated circuit component 1420 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof. A packaged multi-die integrated circuit component can be referred to as a multi-chip package (MCP) or multi-chip module (MCM).

Generally, the interposer 1404 may spread connections to a wider pitch or reroute a connection to a different connection. For example, the interposer 1404 may couple the integrated circuit component 1420 to a set of ball grid array (BGA) conductive contacts of the coupling components 1416 for coupling to the circuit board 1402. In the embodiment illustrated in FIG. 14, the integrated circuit component 1420 and the circuit board 1402 are attached to opposing sides of the interposer 1404; in other embodiments, the integrated circuit component 1420 and the circuit board 1402 may be attached to a same side of the interposer 1404. In some embodiments, three or more components may be interconnected by way of the interposer 1404.

In some embodiments, the interposer 1404 may be formed as a PCB, including multiple metal layers separated from one another by layers of dielectric material and interconnected by electrically conductive vias. In some embodiments, the interposer 1404 may be formed of an epoxy resin, a fiberglass-reinforced epoxy resin, an epoxy resin with inorganic fillers, a ceramic material, or a polymer material such as polyimide. In some embodiments, the interposer 1404 may be formed of alternate rigid or flexible materials that may include the same materials described above for use in a semiconductor substrate, such as silicon, germanium, and other group III-V and group IV materials. The interposer 1404 may include metal interconnects 1408 and vias 1410-1 and 1410-2, including but not limited to through hole vias 1410-1 (that extend from a first face 1450 of the interposer 1404 to a second face 1454 of the interposer 1404), blind vias 1410-2 (that extend from the first or second faces 1450 or 1454 of the interposer 1404 to an internal metal layer), and buried vias 1410-3 (that connect internal metal layers).

In some embodiments, the interposer 1404 can comprise a silicon interposer. Through silicon vias (TSV) extending through the silicon interposer can connect connections on a first face of a silicon interposer to an opposing second face of the silicon interposer. In some embodiments, an interposer 1404 comprising a silicon interposer can further comprise one or more routing layers to route connections on a first face of the interposer 1404 to an opposing second face of the interposer 1404.

The interposer 1404 may further include embedded devices 1414, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1404. The package-on-interposer structure 1436 may take the form of any of the package-on-interposer structures known in the art. In embodiments where the interposer is a non-printed circuit board

The multi-chip package 1400 illustrated in FIG. 14 includes a package-on-package structure 1434 coupled to the second face 1442 of the circuit board 1402 by coupling components 1428. The package-on-package structure 1434 may include an integrated circuit component 1426 and an integrated circuit component 1432 coupled together by coupling components 1430 such that the integrated circuit component 1426 is disposed between the circuit board 1402 and the integrated circuit component 1432. The coupling components 1428 and 1430 may take the form of any of the embodiments of the coupling components 1416 discussed above, and the integrated circuit components 1426 and 1432 may take the form of any of the embodiments of the integrated circuit component 1420 discussed above. The package-on-package structure 1434 may be configured in accordance with any of the package-on-package structures known in the art.

FIG. 15 is a block diagram of an example electrical device 1500 that may include one or more of the embodiments disclosed herein. For example, any suitable electrical device 1500 may include one or more of the multi-chip packages 1400, integrated circuit components 1420, integrated circuits 1300, integrated circuit dies 1202, PICs, FAUs and optical connectors disclosed herein. Although the electrical device 1500 is depicted as including a number of components in FIG. 15, any one or more of these components may be omitted or duplicated, as suitable for the application. In some embodiments, some or all of the components included in the electrical device 1500 may be attached to one or more motherboards mainboards, printed circuit boards, or system boards. In some embodiments, one or more of these components are fabricated onto a single system-on-a-chip (SoC) die.

Additionally, in various embodiments, the electrical device 1500 may not include one or more of the components illustrated in FIG. 15, but the electrical device 1500 may include interface circuitry for coupling to the one or more components. For example, the electrical device 1500 may not include a display device 1506, but may include display device interface circuitry (e.g., a connector and driver circuitry) to which a display device 1506 may be coupled. In another set of examples, the electrical device 1500 may not include an audio input device 1524 or an audio output device 1508, but may include audio input or output device interface circuitry (e.g., connectors and supporting circuitry) to which an audio input device 1524 or audio output device 1508 may be coupled.

The electrical device 1500 may include, within a housing 1501, one or more processor units 1502 (e.g., one or more processor units). As used herein, the terms “processor unit,” “processing unit” or “processor” may refer to any device or portion of a device that processes electronic data from registers and/or memory to transform that electronic data into other electronic data that may be stored in registers and/or memory. The processor unit 1502 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller crypto processors (specialized processors that execute cryptographic algorithms within hardware), server processors, controllers, or any other suitable type of processor units. As such, the processor unit can be referred to as an XPU (or xPU).

The electrical device 1500 may include a memory 1504, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1504 may include memory that is located on the same integrated circuit die as the processor unit 1502. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 1500 can comprise one or more processor units 1502 that are heterogeneous or asymmetric to another processor unit 1502 in the electrical device 1500. There can be a variety of differences between the processing units 1502 in a system in terms of a spectrum of metrics of merit including architectural, microarchitectural, thermal, power consumption characteristics, and the like. These differences can effectively manifest themselves as asymmetry and heterogeneity among the processor units 1502 in the electrical device 1500.

In some embodiments, the electrical device 1500 may include a communication component 1512 (e.g., one or more communication components). For example, the communication component 1512 can manage wireless communications for the transfer of data to and from the electrical device 1500. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1512 may implement any of a number of wireless standards or protocols, including but not limited to Institute for Electrical and Electronic Engineers (IEEE) standards including Wi-Fi (IEEE 1402.11 family), IEEE 1402.16 standards (e.g., IEEE 1402.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 1402.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 1402.16 standards. The communication component 1512 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1512 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1512 may operate in accordance with other wireless protocols in other embodiments. The electrical device 1500 may include an antenna 1522 to facilitate wireless communications and/or to receive other wireless communications (such as AM or FM radio transmissions).

In some embodiments, the communication component 1512 may manage wired communications, such as electrical, optical, or any other suitable communication protocols (e.g., IEEE 1402.3 Ethernet standards). As noted above, the communication component 1512 may include multiple communication components. For instance, a first communication component 1512 may be dedicated to shorter-range wireless communications such as Wi-Fi or Bluetooth, and a second communication component 1512 may be dedicated to longer-range wireless communications such as global positioning system (GPS), EDGE, GPRS, CDMA, WiMAX, LTE, EV-DO, or others. In some embodiments, a first communication component 1512 may be dedicated to wireless communications, and a second communication component 1512 may be dedicated to wired communications.

The electrical device 1500 may include battery/power circuitry 1514. The battery/power circuitry 1514 may include one or more energy storage devices (e.g., batteries or capacitors) and/or circuitry for coupling components of the electrical device 1500 to an energy source separate from the electrical device 1500 (e.g., AC line power).

The electrical device 1500 may include a display device 1506 (or corresponding interface circuitry, as discussed above). The display device 1506 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1500 may include an audio output device 1508 (or corresponding interface circuitry, as discussed above). The audio output device 1508 may include any embedded or wired or wirelessly connected external device that generates an audible indicator, such speakers, headsets, or earbuds.

The electrical device 1500 may include an audio input device 1524 (or corresponding interface circuitry, as discussed above). The audio input device 1524 may include any embedded or wired or wirelessly connected device that generates a signal representative of a sound, such as microphones, microphone arrays, or digital instruments (e.g., instruments having a musical instrument digital interface (MIDI) output). The electrical device 1500 may include a Global Navigation Satellite System (GNSS) device 1518 (or corresponding interface circuitry, as discussed above), such as a Global Positioning System (GPS) device. The GNSS device 1518 may be in communication with a satellite-based system and may determine a geolocation of the electrical device 1500 based on information received from one or more GNSS satellites, as known in the art.

The electrical device 1500 may include another output device 1510 (or corresponding interface circuitry, as discussed above). Examples of the other output device 1510 may include an audio codec, a video codec, a printer, a wired or wireless transmitter for providing information to other devices, or an additional storage device.

The electrical device 1500 may include another input device 1520 (or corresponding interface circuitry, as discussed above). Examples of the other input device 1520 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1500 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1500 may be any other electronic device that processes data. In some embodiments, the electrical device 1500 may comprise multiple discrete physical components. Given the range of devices that the electrical device 1500 can be manifested as in various embodiments, in some embodiments, the electrical device 1500 can be referred to as a computing device or a computing system.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of embodiments has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

In embodiments, the phrase “A is located on B” means that at least a part of A is in direct physical contact or indirect physical contact (having one or more other features between A and B) with at least a part of B.

In the instant description, “A is adjacent to B” means that at least part of A is in direct physical contact with at least a part of B.

In the instant description, “B is between A and C” means that at least part of B is in or along a space separating A and C and that the at least part of B is in direct or indirect physical contact with A and C.

In the instant description, “A is attached to B” means that at least part of A is mechanically attached to at least part of B, either directly or indirectly (having one or more other features between A and B).

In the instant description, “the As are coupled to the Bs” means that at least some of the As are coupled to at least some of the Bs, and not necessarily that all As are coupled to at least one B and all Bs are coupled to at least one A.

In the instant description, “A is within B” means that at least some of A is encompassed within the physical boundaries of B.

The use of reference numerals separated by a “/”, such as “102/104” for example, is intended to refer to 102 or 104 as appropriate. Otherwise, the forward slash (“/”) as used herein means “and/or.”

The use of the techniques and structures provided herein can be detected using tools such as: electron microscopy including scanning/transmission electron microscopy (SEM/TEM), scanning transmission electron microscopy (STEM), nano-beam electron diffraction (NBD or NBED), and reflection electron microscopy (REM); composition mapping; x-ray crystallography or diffraction (XRD); energy-dispersive x-ray spectroscopy (EDX); secondary ion mass spectrometry (SIMS); time-of-flight SIMS (ToF-SIMS); atom probe imaging or tomography; local electrode atom probe (LEAP) techniques; 3D tomography; or high resolution physical or chemical analysis, to name a few suitable example analytical tools. In particular, such tools can indicate an integrated circuit including at least one semiconductor package including an embedded magnetic inductor.

In some embodiments, the techniques, processes and/or methods described herein can be detected based on the structures formed therefrom. In addition, in some embodiments, the techniques and structures described herein can be detected based on the benefits derived therefrom. Numerous configurations and variations will be apparent in light of this disclosure.

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” “according to some embodiments,” “in accordance with embodiments,” or “in embodiments,” which may each refer to one or more of the same or different embodiments. Furthermore, the terms “comprising,” “including,” “having,” and the like, as used with respect to embodiments of the present disclosure, are synonymous.

“Coupled” as used herein means that two or more elements are in direct physical contact, or that that two or more elements indirectly physically contact each other, but yet still cooperate or interact with each other (i.e. one or more other elements are coupled or connected between the elements that are said to be coupled with each other). The term “directly coupled” means that two or more elements are in direct contact.

As used herein, the term “module” refers to being part of, or including an ASIC, an electronic circuit, a system on a chip, a processor (shared, dedicated, or group), a solid state device, a memory (shared, dedicated, or group) that execute one or more software or firmware programs, a combinational logic circuit, and/or other suitable components that provide the described functionality.

As used herein, “electrically conductive” in some examples may refer to a property of a material having an electrical conductivity greater than or equal to 10⁷ Siemens per meter (S/m) at 20 degrees Celsius. Examples of such materials include Cu, Ag, Al, Au, W, Zn and Ni.

In the corresponding drawings of the embodiments, signals, currents, electrical biases, or magnetic or electrical polarities may be represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, polarity, current, voltage, etc., as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the elements that are connected, without any intermediary devices. The term “coupled” means a direct or indirect connection, such as a direct electrical, mechanical, or magnetic connection between the elements that are connected or an indirect connection, through one or more passive or active intermediary devices. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about,” generally refer to being within +/−10% of a target value (unless specifically specified). Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner, and are not intended to imply that the objects so described must necessarily be made of different materials or have different dimensions.

For purposes of the embodiments, any transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors—BJT PNP/NPN, BiCMOS, CMOS, eFET, etc., may be used without departing from the scope of the disclosure. The term “MN” indicates an n-type transistor (e.g., nMOS, NPN BJT, etc.) and the term “MP” indicates a p-type transistor (e.g., pMOS, PNP BJT, etc.).

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

### EXAMPLES

Some non-limiting example embodiments are set forth below.

Example 1 includes an optical connector including: a first lid; and a second lid attached to the first lid to define a cavity therebetween, wherein individual ones of the first lid and the second lid include: a substrate having an inner surface facing the cavity, an outer surface opposite the inner surface, a first end and a second end, the first end to receive a corresponding waveguide therein; and a concave mirror on the substrate and having a reflective surface facing the cavity, wherein a straight linear optical axis is to extend between the reflective surface of the concave mirror and a photonic structure at an opposing one of said individual ones of the first lid and the second lid.

Example 2 includes the subject matter of Example 1, further including the photonic structure, wherein the photonic structure includes one of a planar mirror or the waveguide.

Example 3 includes the subject matter of Example 2, wherein the planar mirror is a prism mirror.

Example 4 includes the subject matter of any one of Examples 1-3, wherein the concave mirror is a toric mirror.

Example 5 includes the subject matter of Example 4, wherein the toric mirror has a long axis extending in a direction from the first end of the substrate of said individual ones of the first lid and the second lid to the second end of the substrate of said individual ones of the first lid and the second lid.

Example 6 includes the subject matter of any one of Examples 1-5, wherein the first lid and the second lid have substantially identical structures.

Example 7 includes the subject matter of any one of Examples 1-6, wherein the substrate includes an optically transparent material.

Example 8 includes the subject matter of Example 7, wherein the optically transparent material includes glass.

Example 9 includes the subject matter of any one of Examples 7-8, wherein the reflective surface of the concave mirror of at least one of the first lid or the second lid is embedded in a material of the substrate of said at least one of the first lid or the second lid.

Example 10 includes the subject matter of Example 9, wherein the reflective surface of the concave mirror of at least one of the first lid or the second lid is disposed at the outer surface of the substrate of said at least one of the first lid or the second lid.

Example 11 includes the subject matter of any one of Examples 1-10, further including an optically transparent spacer disposed between the first lid and the second lid.

Example 12 includes the subject matter of any one of Examples 1-11, wherein the first end defines grooves therein, the corresponding waveguide including an array of fiber optic cables, the grooves to receive the array therein.

Example 13 includes the subject matter of Example 12, at least one of the first lid or the second lid further including the array of fiber optic cables.

Example 14 includes the subject matter of any one of Examples 1-13, wherein the substrate is monolithic.

Example 15 includes a semiconductor assembly including: a package substrate; a photonic integrated circuit (PIC) on the package substrate; and an optical connector optically coupled to the PIC and including: a first lid; and a second lid attached to the first lid to define a cavity therebetween, wherein individual ones of the first lid and the second lid include: an optical connector substrate having an inner surface facing the cavity, an outer surface opposite the inner surface, a first end and a second end; a waveguide received at the first end, wherein the waveguide at the first end of the first lid is part of or coupled to the PIC; and a concave mirror on the optical connector substrate and having a reflective surface facing the cavity, wherein a straight linear optical axis is to extend between the reflective surface of the concave mirror and a photonic structure at an opposing one of said individual ones of the first lid and the second lid.

?

Example 16 includes the subject matter of Example 15, further including the photonic structure, wherein the photonic structure includes one of a planar mirror or the waveguide.

Example 17 includes the subject matter of Example 16, wherein the planar mirror is a prism mirror.

Example 18 includes the subject matter of any one of Examples 15-17, wherein the concave mirror is a toric mirror.

Example 19 includes the subject matter of Example 18, wherein the toric mirror has a long axis extending in a direction from the first end of the optical connector substrate of said individual ones of the first lid and the second lid to the second end of the optical connector substrate of said individual ones of the first lid and the second lid.

Example 20 includes the subject matter of any one of Examples 15-19, wherein the first lid and the second lid have substantially identical structures.

Example 21 includes the subject matter of any one of Examples 15-20, wherein the optical connector substrate includes an optically transparent material.

Example 22 includes the subject matter of Example 21, wherein the optically transparent material includes glass.

Example 23 includes the subject matter of any one of Examples 21-22, wherein the reflective surface of the concave mirror of at least one of the first lid or the second lid is embedded in a material of the optical connector substrate of said at least one of the first lid or the second lid.

Example 24 includes the subject matter of Example 23, wherein the reflective surface of the concave mirror of at least one of the first lid or the second lid is disposed at the outer surface of the optical connector substrate of said at least one of the first lid or the second lid.

Example 25 includes the subject matter of any one of Examples 15-22, further including an optically transparent spacer disposed between the first lid and the second lid.

Example 26 includes the subject matter of any one of Examples 15-25, wherein the first end defines grooves therein, the waveguide including an array of fiber optic cables in the grooves.

Example 27 includes the subject matter of Example 26, at least one of the first lid or the second lid further including the array of fiber optic cables.

Example 28 includes the subject matter of any one of Examples 15-27, wherein the optical connector substrate is monolithic.

Example 29 includes the subject matter of any one of Examples 15-28, wherein the PIC is a first PIC, the semiconductor assembly further including a second PIC on the package substrate, wherein the waveguide at the first end of the second lid is part of or coupled to the second PIC, and wherein the optical connector optically couples the first PIC to the second PIC.

Example 30 includes the subject matter of any one of Examples 15-28, the optical connector further including a fiber array unit (FAU), wherein the waveguide at the first end of the second lid is part of the FAU, and wherein the optical connector optically couples the PIC to the FAU.

Example 31 includes a multi-chip package including: a package substrate; a plurality of integrated circuit components on the package substrate; a photonic integrated circuit (PIC) on the package substrate; and an optical connector optically coupled to the PIC and including: a first lid; and a second lid attached to the first lid to define a cavity therebetween, wherein individual ones of the first lid and the second lid include: an optical connector substrate having an inner surface facing the cavity, an outer surface opposite the inner surface, a first end and a second end; a waveguide received at the first end, wherein the waveguide at the first end of the first lid is part of or coupled to the PIC; and a concave mirror on the optical connector substrate and having a reflective surface facing the cavity, wherein a straight linear optical axis is to extend between the reflective surface of the concave mirror and a photonic structure at an opposing one of said individual ones of the first lid and the second lid.

Example 32 includes the subject matter of Example 31, further including the photonic structure, wherein the photonic structure includes one of a planar mirror or the waveguide.

Example 33 includes the subject matter of Example 32, wherein the planar mirror is a prism mirror.

Example 34 includes the subject matter of any one of Examples 31-33, wherein the concave mirror is a toric mirror.

Example 35 includes the subject matter of Example 34, wherein the toric mirror has a long axis extending in a direction from the first end of the optical connector substrate of said individual ones of the first lid and the second lid to the second end of the optical connector substrate of said individual ones of the first lid and the second lid.

Example 36 includes the subject matter of any one of Examples 31-35, wherein the first lid and the second lid have substantially identical structures.

Example 37 includes the subject matter of any one of Examples 31-36, wherein the optical connector substrate includes an optically transparent material.

Example 38 includes the subject matter of Example 37, wherein the optically transparent material includes glass.

Example 39 includes the subject matter of any one of Examples 21-38, wherein the reflective surface of the concave mirror of at least one of the first lid or the second lid is embedded in a material of the optical connector substrate of said at least one of the first lid or the second lid.

Example 40 includes the subject matter of Example 39, wherein the reflective surface of the concave mirror of at least one of the first lid or the second lid is disposed at the outer surface of the optical connector substrate of said at least one of the first lid or the second lid.

Example 41 includes the subject matter of any one of Examples 31-38, further including an optically transparent spacer disposed between the first lid and the second lid.

Example 42 includes the subject matter of any one of Examples 31-41, wherein the first end defines grooves therein, the waveguide including an array of fiber optic cables in the grooves.

Example 43 includes the subject matter of Example 26, at least one of the first lid or the second lid further including the array of fiber optic cables.

Example 44 includes the subject matter of any one of Examples 31-43, wherein the optical connector substrate is monolithic.

Example 45 includes the subject matter of any one of Examples 31-44, wherein the PIC is a first PIC, further including a second PIC on the package substrate, wherein the waveguide at the first end of the second lid is part of or coupled to the PIC, and wherein the optical connector optically couples the first PIC to the second pic on the MCP.

Example 46 includes the subject matter of any one of Examples 31-45, the optical connector further including a fiber array unit (FAU), wherein the waveguide at the first end of the second lid is part of the FAU, and wherein the optical connector optically couples the PIC to the FAU.

Example 47 includes a method of making an optical connector including: providing a first substrate having a first end and a second end, the first end of the first substrate to receive a first waveguide therein; providing a second substrate having a first end and a second end, the first end of the second substrate to receive a second waveguide therein; forming a first lid by providing, on the first substrate, a first concave mirror having a first reflective surface; forming a second lid by providing, on the second substrate, a second concave mirror having a second reflective surface; assembling the first lid and the second lid to define a cavity therebetween, the first reflective surface and the second reflective surface facing the cavity, wherein: a first straight linear optical axis is to extend between the first reflective surface and a second photonic structure on the second substrate; and a second straight linear optical axis is to extend between the second reflective surface and a first photonic structure on the first substrate.

Example 48 includes the subject matter of Example 47, wherein providing the first substrate and the second substrate includes: providing a sheet of material; performing a molding process on the sheet of material to form a panel including a plurality of interconnected substrates that include the first substrate and the second substrate.

Example 49 includes the subject matter of Example 48, further including: providing concave mirrors on respective ones of the plurality of interconnected substrates including providing the first concave mirror on the first substrate and the second concave mirror on the second substrate; providing photonic structures on respective ones of the plurality of interconnected substrates including providing the first photonic structure on the first substrate and the second photonic structure on the second substrate; singulating the panel after providing the concave mirrors and after providing the photonic structures to yield a plurality of lids including the first lid and the second lid.

Example 50 includes the subject matter of any one of Examples 47-49, wherein the first photonic structure includes one of the first waveguide or a first planar mirror, and the second photonic structure includes one of the second waveguide or a second planar mirror.

Example 51 includes the subject matter of Example 50, wherein

individual ones of the first planar mirror and the second planar mirror correspond to a prism mirror.

Example 52 includes the subject matter of any one of Examples 47-51, wherein at least one of the first concave mirror or the second concave mirror is a toric mirror.

Example 53 includes the subject matter of Example 52, wherein the toric mirror has a long axis extending in a direction from the first waveguide to the second waveguide.

Example 54 includes the subject matter of any one of Examples 47-53, wherein the first lid and the second lid have substantially identical structures.

Example 55 includes the subject matter of any one of Examples 47-54, wherein at least one of the first substrate or the second substrate includes an optically transparent material.

Example 56 includes the subject matter of Example 55, wherein the optically transparent material includes glass.

Example 57 includes the subject matter of any one of Examples 55-56, further including embedding at least one of the first reflective surface or the second reflective surface in a material of a corresponding one of the first substrate or the second substrate.

Example 58 includes the subject matter of Example 57, further including providing at least one of the first reflective surface or the second reflective surface at an outer surface of a corresponding one of the first substrate or the second substrate.

Example 59 includes the subject matter of any one of Examples 47-58, further including providing an optically transparent spacer between the first lid and the second lid.

Example 60 includes the subject matter of any one of Examples 47-59, wherein the first end of the first substate, the second end of the first substrate, the first end of the second substrate and the second end of the second substrate define grooves therein, the first waveguide and the second waveguide including respective arrays of fiber optic cables, the grooves to receive corresponding ones of the arrays therein.

Example 61 includes the subject matter of Example 60, further including providing the arrays of fiber optic cables within corresponding ones of the grooves.

Example 62 includes the subject matter of any one of Examples 47-61, wherein at least one of the first substrate or the second substrate is monolithic.

What is claimed is:

1. An optical connector including:
a first lid; and
a second lid attached to the first lid to define a cavity therebetween, wherein individual ones of the first lid and the second lid include:
a substrate having an inner surface facing the cavity, an outer surface opposite the inner surface, a first end and a second end, the first end to receive a waveguide therein; and
a concave mirror on the substrate and having a reflective surface facing the cavity, wherein a straight linear optical axis is to extend between the reflective surface of the concave mirror and a photonic structure at an opposing one of said individual ones of the first lid and the second lid.

2. The optical connector of claim 1, further including the photonic structure, wherein the photonic structure includes one of a planar mirror or the waveguide.

3. The optical connector of claim 2, wherein the planar mirror is a prism mirror and the concave mirror is a toric mirror.

4. The optical connector of claim 3, wherein the toric mirror has a long axis extending in a direction from the first end of the substrate of said individual ones of the first lid and the second lid to the second end of the substrate of said individual ones of the first lid and the second lid.

5. The optical connector of claim 1, wherein the first lid and the second lid have substantially identical structures.

6. The optical connector of claim 1, wherein the substrate includes an optically transparent material.

7. The optical connector of claim 6, wherein the optically transparent material includes glass.

8. The optical connector of claim 6, wherein the reflective surface of the concave mirror of at least one of the first lid or the second lid is embedded in a material of the substrate of said at least one of the first lid or the second lid.

9. The optical connector of claim 8, wherein the reflective surface of the concave mirror of at least one of the first lid or the second lid is disposed at the outer surface of the substrate of said at least one of the first lid or the second lid.

10. The optical connector of claim 1, further including an optically transparent spacer disposed between the first lid and the second lid.

11. The optical connector of claim 1, wherein the first end defines grooves therein, a corresponding waveguide including an array of fiber optic cables, the grooves to receive the array therein.

12. The optical connector of claim 1, wherein the substrate is monolithic.

13. A semiconductor assembly including:
a package substrate,
a photonic integrated circuit (PIC) on the package substrate; and
an optical connector optically coupled to the PIC and including:
a first lid; and
a second lid attached to the first lid to define a cavity therebetween, wherein individual ones of the first lid and the second lid include:
an optical connector substrate having an inner surface facing the cavity, an outer surface opposite the inner surface, a first end and a second end;
a waveguide received at the first end, wherein the waveguide at the first end of the first lid is part of or coupled to the PIC; and
a concave mirror on the optical connector substrate and having a reflective surface facing the cavity, wherein a straight linear optical axis is to extend between the reflective surface of the concave mirror and a photonic structure at an opposing one of said individual ones of the first lid and the second lid.

14. The semiconductor assembly of claim 13, further including the photonic structure, wherein the photonic structure includes one of a prism mirror or the waveguide.

15. The semiconductor assembly of claim 13, wherein the concave mirror is a toric mirror having a long axis extending in a direction from the first end of the optical connector substrate of said individual ones of the first lid and the second lid to the second end of the optical connector substrate of said individual ones of the first lid and the second lid.

16. The semiconductor assembly of claim 13, wherein the first lid and the second lid have substantially identical structures.

17. The semiconductor assembly of claim 13, wherein the substrate includes an optically transparent material.

18. A method of making an optical connector including:
providing a first substrate having a first end and a second end, the first end of the first substrate to receive a first waveguide therein;
providing a second substrate having a first end and a second end, the first end of the second substrate to receive a second waveguide therein;
forming a first lid by providing, on the first substrate, a first concave mirror having a first reflective surface;
forming a second lid by providing, on the second substrate, a second concave mirror having a second reflective surface;
assembling the first lid and the second lid to define a cavity therebetween, the first reflective surface and the second reflective surface facing the cavity, wherein:
a first straight linear optical axis is to extend between the first reflective surface and a second photonic structure on the second substrate; and
a second straight linear optical axis is to extend between the second reflective surface and a first photonic structure on the first substrate.

19. The method of claim 18, wherein providing the first substrate and the second substrate includes:
providing a sheet of material;
performing a molding process on the sheet of material to form a panel including a plurality of interconnected substrates that include the first substrate and the second substrate.

20. The method of claim 19, further including:
providing concave mirrors on respective ones of the plurality of interconnected substrates including providing the first concave mirror on the first substrate and the second concave mirror on the second substrate;
providing photonic structures on respective ones of the plurality of interconnected substrates including providing the first photonic structure on the first substrate and the second photonic structure on the second substrate;
singulating the panel after providing the concave mirrors and after providing the photonic structures to yield a plurality of lids including the first lid and the second lid.
